(19) United States
(12) Patent Application Publication
(10) Pub. No.: US 2025/0337333 A1
(43) Pub. Date: Oct. 30, 2025

(54) CONFIGURABLE DRIVER CIRCUITRY FOR BI-DIRECTIONAL POWER CONVERSION

(71) Applicant: Infineon Technologies Austria AG, Villach (AT)

(72) Inventors: Zhe LI, Gimpo (KR); Rafael Antonio GARCIA MORA, Villach (AT); Tin Chee CHAN, München (DE); Anthony SANDERS, Weißenfeld (DE)

(21) Appl. No.: 18/649,269

(22) Filed: Apr. 29, 2024

(51) Int. Cl. H02M 3/335; B60L 53/22; H02J 7/02; H02M 1/00

(52) U.S. Cl. CPC H02M 3/33584; B60L 53/22; H02J 7/02; H02M 1/0009; B60L 2210/10; H02J 2207/20

(57) ABSTRACT

Driver circuitry configured to operate in a first mode or a second mode to drive a power switch is described. The driver circuitry is operable in a first mode in which the driver circuitry controls the power switch to turn off when, or slightly before, a current through the secondary side switch crosses zero. The driver circuitry is also operable in a second mode in which the driver circuitry controls the power switch to turn on and turn off based a driver input signal from a controller.

### TECHNICAL FIELD OF THE INVENTION

This invention relates generally to power conversion, and more specifically to bi-directional power conversion.

### BACKGROUND

DCDC converters may be used to transfer energy between a Direct Current (DC) energy source and a DC load. As an example application, DCDC converters may be used as part of charging circuitry, for example to charge a battery from another power source, for example another battery.

In some applications, it may be desirable to implement bi-directional charging between batteries. In some examples, transferring energy between batteries may present unique challenges. For example, a condition of each battery as a source or load may vary drastically depending on an amount of energy stored in the battery and/or a current use of the battery.

A need exists for DCDC converters that are adapted to support bi-directional charging between electrically isolated batteries that are energy efficient and can be implemented with reduced cost and/or complexity in comparison to traditional converters.

### SUMMARY

This disclosure is directed to power conversion using drive circuitry that is configurable between first and second modes to drive secondary side switches of a power converter. According to one example, an integrated device includes driver circuitry configured to, in a first mode when a current through a power switch flows in a first direction from a source of the power switch to a drain of the power switch, control the power switch to turn off when, or slightly before, the current through the power switch crosses zero. The driver circuitry is further configured to, in a second mode when the current through the power switch flows in a second direction from the drain of the power switch to the source of the power switch, control the power switch to turn on and turn off based on a driver input signal from a controller.

According to another example, a bi-directional power converter includes a primary side of a transformer that includes a primary side switch and a primary side terminal. The bi-directional power converter further includes a secondary side of the transformer that includes a secondary side switch and a secondary side terminal. The bi-directional power converter further includes driver circuitry configured to drive the secondary side switch, and controllable to operate in: a first mode in which the driver circuitry controls the secondary side switch to transfer energy from the primary side terminal to the secondary side terminal based on causing the secondary side switch to turn off when, or slightly before, a current through the secondary side switch crosses zero, and a second mode in which the driver circuitry controls the secondary side switch to turn on and turn off to transfer energy from the secondary side terminal to the primary side terminal based a driver input signal from a controller.

According to another example, a method includes operating driver circuitry of a power converter in a first mode when a current through a power switch flows in a first direction from a source of the power switch to a drain of the secondary side switch, wherein in the first mode the driver circuitry controls the power switch to turn off when, or slightly before, the current through the power switch crosses zero. The method further includes operating the driver circuitry of the power converter in a second mode when the current through the power switch flows in a second direction from the drain of the power switch to the source of the power switch, wherein in the second mode, the driver circuitry controls the power switch to turn on and turn off based on a driver input signal from a controller.

### BRIEF DESCRIPTION OF THE DRAWINGS

The present invention will now be described, by way of example with reference to the accompanying drawings, in which:

FIG. 1 is a block diagram that illustrates one example of a bi-directional power converter according to some embodiments.

FIG. 2 is a block diagram that depicts one example of a bi-directional boost buck power converter according to some embodiments.

FIG. 3 is a block diagram depicting one example of a vehicle power system according to some embodiments.

FIGS. 4A and 4B are a timing diagrams that show a driver output signal generated by driver circuitry operated in a first mode according to some embodiments.

FIG. 4C is a timing diagram that shows a driver output signal generated by the driver circuitry operated in a second mode according to some embodiments.

FIG. 5 is a block diagram that depicts driver circuitry configured to operate in a first mode, or a second mode according to some embodiments.

FIG. 6 is a block diagram depicting another example of driver circuitry configured to be operable in a first mode or a second mode according to some embodiments.

FIG. 7 is a block diagram that depicts one example of the driver circuitry configurable in a first mode or a second mode housed within a package according to some embodiments.

FIG. 8 is a block diagram that illustrates one example of an integrated device which includes both a power switch and drive circuity configurable in a first mode and a second mode to control the power switch according to some embodiments.

FIG. 9A is a block diagram that illustrates one example of an integrated device that includes a power switch with an integrated current sense circuit and drive circuity configurable in a first mode and a second mode to control the power switch according to some embodiments.

FIGS. 9B and 9C depict top down and side views, respectively, of an integrated device that includes a laterally arranged power switch with an integrated current sense circuit and drive circuity configurable in a first mode and a second mode to control the power switch according to some embodiments.

FIG. 10 is a block diagram depicting one example of a converter system that includes integrated devices implemented as secondary side switches of a converter according to some embodiments.

FIG. 11 is a block diagram depicting one example of the driver circuitry depicted in FIG. 6 with first and second circuits housed in separate packages according to some embodiments.

FIG. 12 is a flow diagram that depicts one example of a method of operating driver circuitry configurable in a first mode and a second mode according to some embodiments.

### DETAILED DESCRIPTION

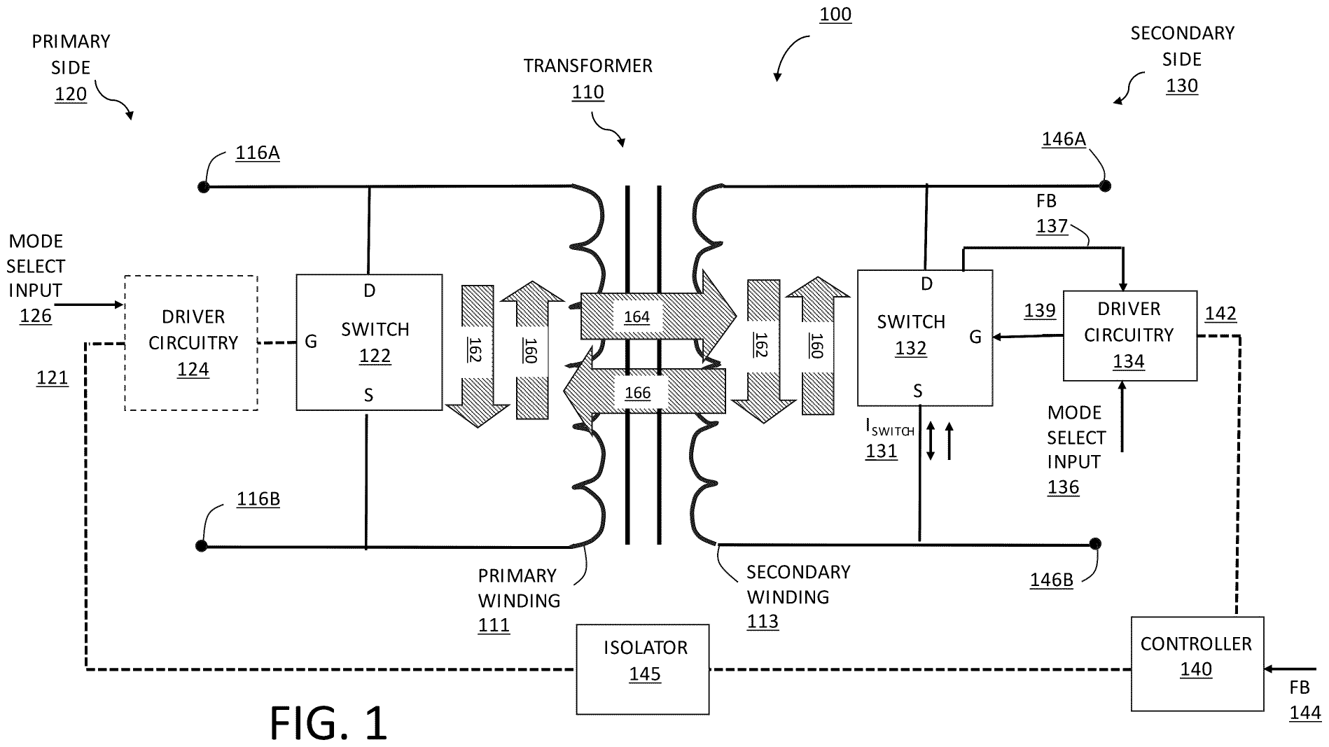

FIG. 1 is a block diagram that illustrates one example of a power converter 100 according to some embodiments. The power converter 100 includes a transformer 110 with a primary side 120 that includes a pair of primary side terminals 116A, 116B coupled to a primary winding 111 of the transformer 110. The power converter 100 also includes a secondary side 130 that includes a pair of secondary side terminals 146A, 146B coupled to a secondary winding 113 of the transformer 110.

Power converter 100 is configured to transfer direct current (DC) energy electrically isolated by the transformer 110 between the primary side terminals 116A, 116B and the secondary side terminals 146A, 146B. For example, converter 100 may be configured to transfer energy from a DC energy source connected to the primary side terminals 116A, 116B to a load connected to the secondary side terminals 146A, 146B.

As shown in the FIG. 1 example, power converter 100 further includes at least one secondary side switch 132 and at least one primary side switch 122 that are operable to regulate the transfer of energy between the primary side terminals 116A, 116B and the secondary side terminals 146A, 146B via the transformer 110. The secondary side switch 132 is coupled to secondary side winding 113 on the secondary side 130 of converter 100, and the primary side switch 134 is coupled to the primary side winding 111 on the primary side 120 of converter 100. The secondary side switch 132 and the primary side switch 122 depicted in FIG. 1 are each power transistors, which are transistor components specifically designed to be switched on and off to regulate the transfer of energy.

In some examples, the secondary side switch 132 and/or the primary side switch 122 may be silicon metal oxide semiconductor field effect (MOSFET) power switches. In other examples the secondary side switch 132 and/or the primary side switch 122 may be high electron mobility transistors (HEMT) formed of III-V semiconductor material, such as Gallium Nitride or a Silicon Carbide. In some examples, the secondary side switch 132 and/or the primary side switch 122 may be a gallium nitride power switches with a Schottky gate, which is “semi-isolated” by back-to-back diodes that prevent significant current flow in order to emulate a gate of a silicon MOSFET power switch. In other examples, such a gallium nitride power switch may have an ohmic gate (e.g., a Gate Injection Transistor). In some examples, the secondary side switch 132 and/or the primary side switch 122 are laterally arranged, for example with gate, source, and drain connections all presented on a planar surface of a semiconductor substrate coupled to a lateral conduction channel. In other examples the secondary side switch 132 and/or the primary side switch 122 are vertically arranged power transistors with drain and source terminals on opposed surfaces of a substrate coupled to a vertical conduction channel between the opposed source and drain terminals.

In some examples, the switches 122, 132, which may include multiple primary side switches 122 and multiple secondary side switches 132 in some embodiments, have voltage rating(s) that corresponds to a load/energy source at the respective primary side terminals 116A, 116B and secondary side terminals 146A, 146B. As one non-limiting example, if a high voltage (HV) battery that stores energy at up to hundreds of volts is coupled to the primary side terminals 116A, 116B, the primary side power switch (or switches) 122 may have a voltage rating to collectively support switching hundreds of volts. As another non-limiting example, if a low voltage (LV) battery that stores energy 12 volts is coupled to the secondary side terminals 146A, 146B, the secondary side switch (or switches) 132 may have a voltage rating to collectively support switching at least 12 volts. As another non-limiting example, if a low voltage (LV) battery that stores energy at 24 or 48 volts is coupled to the secondary side terminals 146A, 146B, the secondary side switch (or switches) 132 may have a voltage rating to collectively support switching at least 24 or 48 volts.

In some examples, power converter 100 may be operable to transfer energy across the transformer 110 using active synchronous rectification, in which the primary side switch 122 and the secondary side switch 132 are driven (switched on and off) in a complimentary manner to transfer energy across the transformer 110. In some examples, active synchronous rectification may enable power converter 100 to be operated with high efficiency.

In some traditional power converters, to operate using active synchronous rectification, the secondary side switches are driven by a controller that controls both the primary side switches and the secondary side switches to switch synchronously with one another. For example, a traditional controller may control the primary and secondary side switches to transfer a desired amount of energy based at least in part on system feedback such as a measured input current/voltage at a primary side power source and/or a measured current/voltage at a secondary side load.

In some examples, operating traditional power converters using synchronous rectification may risk damage to the primary side switches in some operating conditions. For example, controlling both primary side switch and secondary side switches actively with a controller may risk damage to the primary side switches if they enter discontinuous conduction mode (DCM) when operated in light load or light source conditions. To address this issue, some traditional power converters are adapted to disable active control of the secondary side switches before the converter operates in DCM to avoid potential damage to (e.g., explosion) to the primary side switches. In some applications, for example when operating conditions vary in wide ranges, it may be challenging to establish a threshold to disable active control of the secondary side switches to protect the primary side switches without sacrificing converter efficiency. According to these examples, a threshold set too low may risk damage to the primary side switches, and a threshold set high enough to protect the primary side switch across all operating conditions may cause the traditional converter to rarely operate using active synchronous rectification, which may detrimentally impact converter efficiency.

In other examples, instead of using a controller to control the primary side switches and the secondary side switches to switch synchronously, traditional converters may employ “self-driven” gate drivers configured to control the secondary side switches based on feedback that is local to the secondary side switches, instead of based on an external control signal from a controller such that the secondary side switches are actively switched synchronous with the primary side switches without risk of damage to the primary side switches even under a wide range of input/output conditions. For example, such a traditional self-driven gate driver may measure a voltage V_{DS} across the drain and source terminals of a secondary side switch as an approximation of a current through the secondary side switch, and turn the secondary side switch on and off based on the measured voltage V_{DS}. For example, such a traditional self-driven gate driver may turn secondary side switches on and off when or shortly before the measured voltage V_{DS} indicates a current through the secondary side switch will cross zero. In some examples, traditional self-driven gate drivers may only be operable in one direction of energy transfer, for example to transfer energy from the primary side to the secondary side of a converter.

In order to support bi-directional power conversion for some applications, some traditional systems incorporate separate power converters to transfer energy in each direction. For example, to transfer energy bi-directionally between high voltage HV battery and low voltage LV battery for charging, a traditional system may include a first converter to transfer energy in a first direction (e.g., to charge the LV battery from a HV battery), and a separate, second converter, including duplicate primary and secondary side switches, to transfer energy in the second direction (e.g., to charge the HV battery from a LV battery).

Referring again to FIG. 1, power converter 100 is uniquely adapted to support bi-directional charging with high efficiency using active synchronous rectification without using separate converters. According to the example of FIG. 1, power converter 100 is configurable to transfer energy in a first direction 164 to transfer energy from an energy source coupled to the primary side terminals 116A, 116B to a load coupled to the secondary side terminals 146A, 146B. According to this example, power converter 100 is also configurable to transfer energy in a second direction 166, to transfer energy from an energy source coupled to the secondary side terminals 146A, 146B to a load coupled to the primary side terminals 116A, 116B. In some examples, when power converter 100 is operated to transfer energy in the first direction 164, a current I_{SWITCH} through the secondary side switch flows in a first direction 160 from a source to a drain of the secondary side switch 132, and a current I_{SWITCH} through the primary side switch 122 flows in a second direction 162 from a drain to a source of the primary side switch 122. In some examples, when power converter 100 is operated to transfer energy in the second direction 166, the current I_{SWITCH} through the secondary side switch 132 flows in a second direction 162 from a drain to a source of the secondary side switch 132, and the current I_{SWITCH} through the primary side switch 122 flows in the first direction 160 from the source to the drain of the primary side switch 122.

According to the example, of FIG. 1, power converter 100 includes driver circuitry 134 that is configurable to operate in a first mode or a second mode. In the first mode, the driver circuitry 134 controls the secondary side switch 132 (via driver output signal 139 output to a gate of the secondary side switch 132) to turn off (i.e., stop conducting current through the secondary side switch 132), when, or slightly before, a current I_{SWITCH} 131 through the secondary side switch 132 crosses zero. In the second mode, the driver circuitry 134 controls the secondary side switch 132 to turn on and turn off based on a driver input signal 142 from the controller 140. In the second mode, the driver circuitry 134 controls the secondary side switch 132 to turn on and turn off based on a driver input signal 142 from the controller 140.

In the first mode, the driver circuitry 134 controls the secondary side switch 132 based on switch feedback 137 from the secondary side switch 132, that indicates zero crossings of a current I_{SWITCH} 131 through the secondary side switch 132. The current I_{SWITCH} 131 is a current through a conduction channel of the secondary side switch, for example that flows from a drain terminal of the secondary side switch 132 to a source terminal of the secondary side switch 132, or from the source terminal of the secondary side switch 132 to the drain terminal of the secondary side switch 132. In some examples, the feedback 137 is a measured voltage V_{DS} across the secondary side switch 132 that serves as an approximation of a current I_{SWITCH} 131 to identify zero crossings of the current I_{SWITCH} 131. In other examples, the feedback is based on a direct measurement of the current I_{SWITCH} 131 through the secondary side switch 132, for example when the secondary side switch 132 includes an integrated current sense circuit (not shown in FIG. 1).

In the example of FIG. 1, the controller 140 is arranged on the secondary side 130 of transformer 110 and is configured to control the primary side switch 122 via primary side driver circuitry 124 coupled to the controller 140 through an isolator 145. In other examples not depicted, the controller is arranged on the primary side 120 of transformer 110 and is configured to control the secondary side switch 132 in the second mode via an isolator.

In some examples, driver circuitry 134 may be controllable in the first mode or the second mode based on a direction 160, 162 of a current flow through the secondary side switch 132. For example, as shown by the arrows in FIG. 1, driver circuitry 134 may be operated in the first mode when a current through the secondary side switch 132 flow in a first direction 160 (e.g., from a source to a drain of the secondary side switch 132), for example when the converter 100 is operated to transfer energy from primary side terminals 116A, 116B to the secondary side terminals 146A, 146B in the first direction 164. As also shown by the arrows in FIG. 1, driver circuitry 134 may be operated in the second mode when a current through the secondary side switch 132 flows in a second direction 162 (e.g., from a drain to a source of the secondary side switch 132), for example when converter 100 is operated to transfer energy from an the secondary side terminals 146A, 146B to the primary side terminals 116A, 116B in the second direction 166.

As shown in FIG. 1, the primary side 120 also includes primary side driver circuitry 124 to control the primary side switch 122. In some examples, the primary side driver circuitry 124 is operable to turn on and off the primary side switch 122 based on a driver input signal 121 from controller 140, regardless of a direction of energy transfer 164, 166 of converter 100 and/or a direction of current flow 160, 162 through the primary side switch 122.

In other examples, the primary side driver circuitry 124 is also configurable to operate in the first and second modes as described herein. According to these examples, primary side driver circuitry 124 may be controlled in the second mode (to turn on and off based on the driver input signal 121 from controller 140) when energy is transferred in the first direction 164 shown in FIG. 1. According to these examples, the primary side driver circuitry 124 may be operated in the first mode (to turn off when, or slightly before, a current through the primary side switch 122 crosses zero) when energy is transferred in the second direction 166 shown in FIG. 1.

In some examples, the secondary side driver circuitry 134 may be operated in the first or second mode based on a control signal from a controller 140 applied to the mode select input 136. For examples, the controller 140 may apply the control signal to the mode select input 136 based on a desired charging direction of converter 100, for example whether converter 100 is operated to transfer energy in the first direction 164 or the second direction 166 depicted in FIG. 1.

In other examples, the secondary side driver circuitry 134 may be self-configurable and does not include mode select input 136. According to these examples, the secondary side driver circuitry 134 is configured to detect a direction of current flow through the secondary side switch 132 (e.g., based on switch feedback 137), and operate in the first or second mode based on the detected direction of current flow. For example, the secondary side driver circuity 134 may operate in the first mode in response to detecting a first direction 160 of current flow through the secondary side switch 132 (from a source to a drain of the secondary side switch 132), and operate in the second mode in response to detecting a second direction 162 of current flow through the secondary side switch 132 (from a drain to a source of the secondary side switch 132).

In still other examples, the primary side driver circuitry 124 may also be self-configurable to independently switch between the first mode and the second mode, based on switch feedback (not depicted in FIG. 1) from the primary side switch 122 that indicates a direction of current flow through the primary side switch 122. According to these examples, the primary side driver circuity 124 is self-configurable to, like secondary side driver circuitry 134, operate in the first mode in response to detecting the first direction 160 (from a source to drain) of current flow through the primary side switch 122, and to operate in the second mode in response to detecting the second direction 162 (from a drain to source) of current flow through the primary side switch 122.

Converter 100, which incorporates driver circuitry 134 configurable in first and second modes, may offer benefits in comparison to traditional power converters. For example, converter 100 may be particularly suited to supporting bi-directional energy transfer with high efficiency and therefore reduced energy usage across a wide range of input and output conditions with a single converter 100, without incorporate multiple converters to support bi-directional energy transfer.

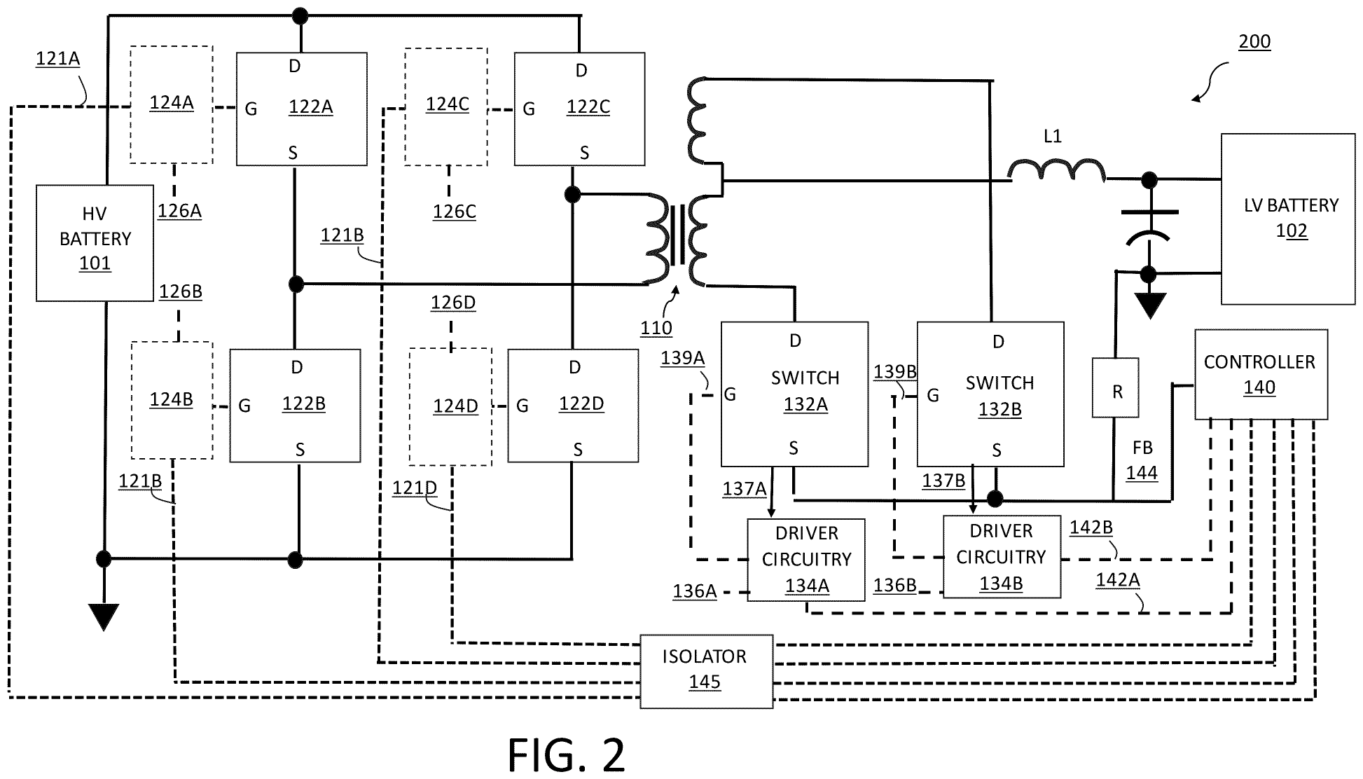

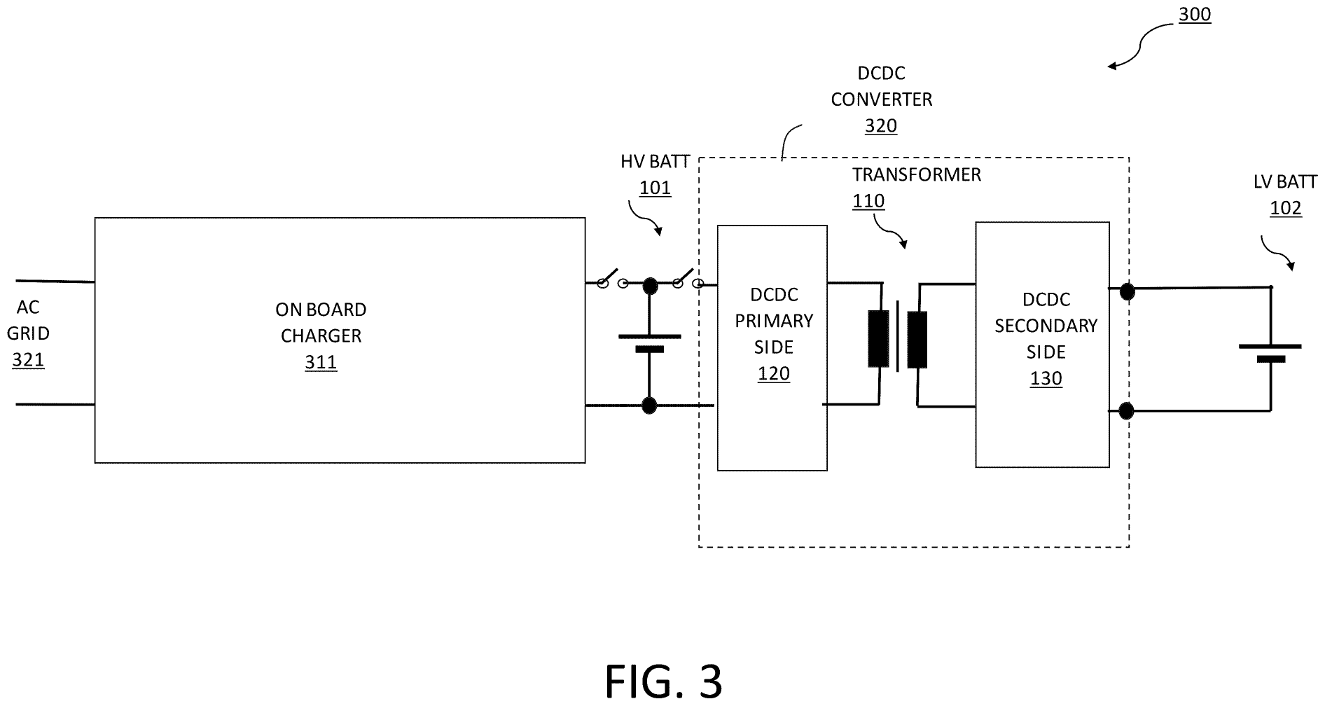

Various embodiments of driver circuitry 134 are described. For example, converter 100 may be implemented as a buck-boost converter as depicted in FIG. 2, or used in any other power converter topology not depicted. In some examples, DCDC converter may be used to support bi-directional charging between a high-voltage (HV) battery 101 of a vehicle and a low voltage (LV) battery 102 of the vehicle as shown in FIGS. 2 and 3.

Referring again to FIG. 1, the driver circuitry 134 is operable in a first mode to turn off the secondary side switch 132 to turn off, when, or slightly before, a current I_{SWITCH} 131 through the secondary side switch 132 crosses zero. In some examples, in the first mode, the driver circuitry 134 also turns the secondary side switch on when, or slightly before, the current I_{SWITCH} 131 crosses zero. In other examples, in the first mode, the driver circuitry 134 turns the secondary side switch 132 on based on a driver input signal 142 from a controller 140.

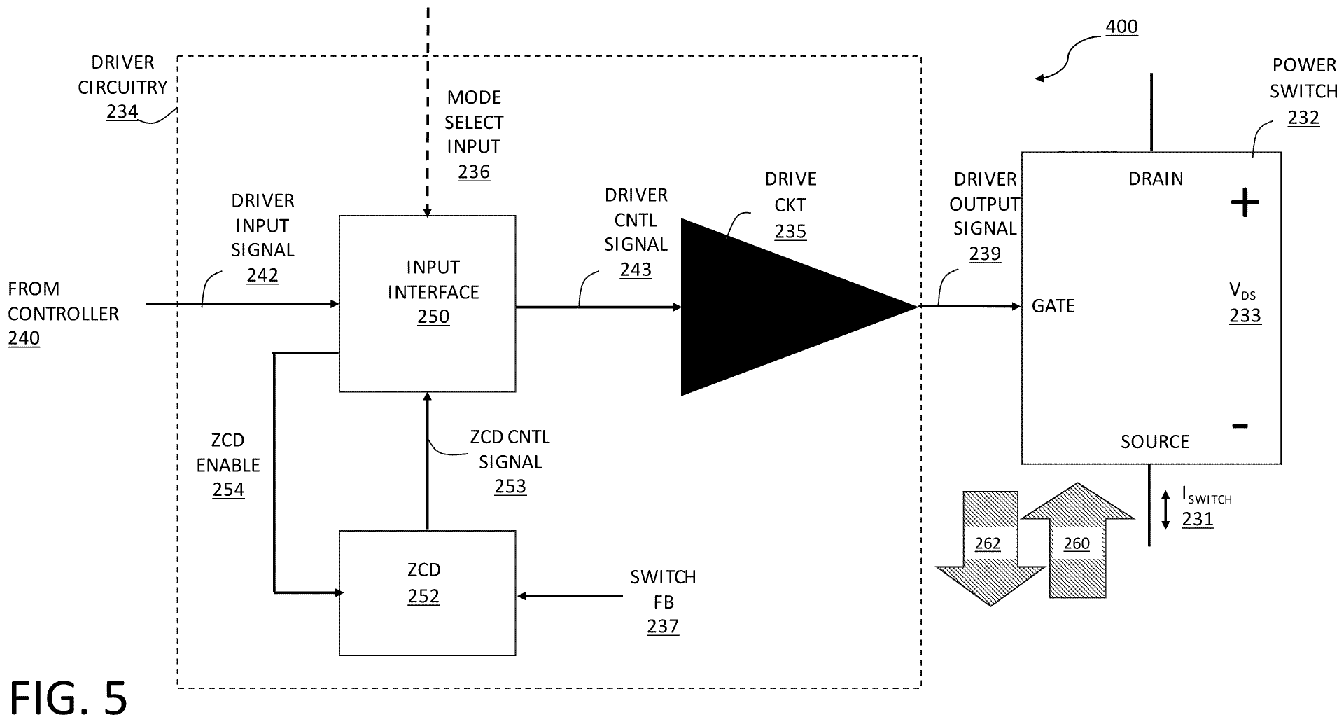

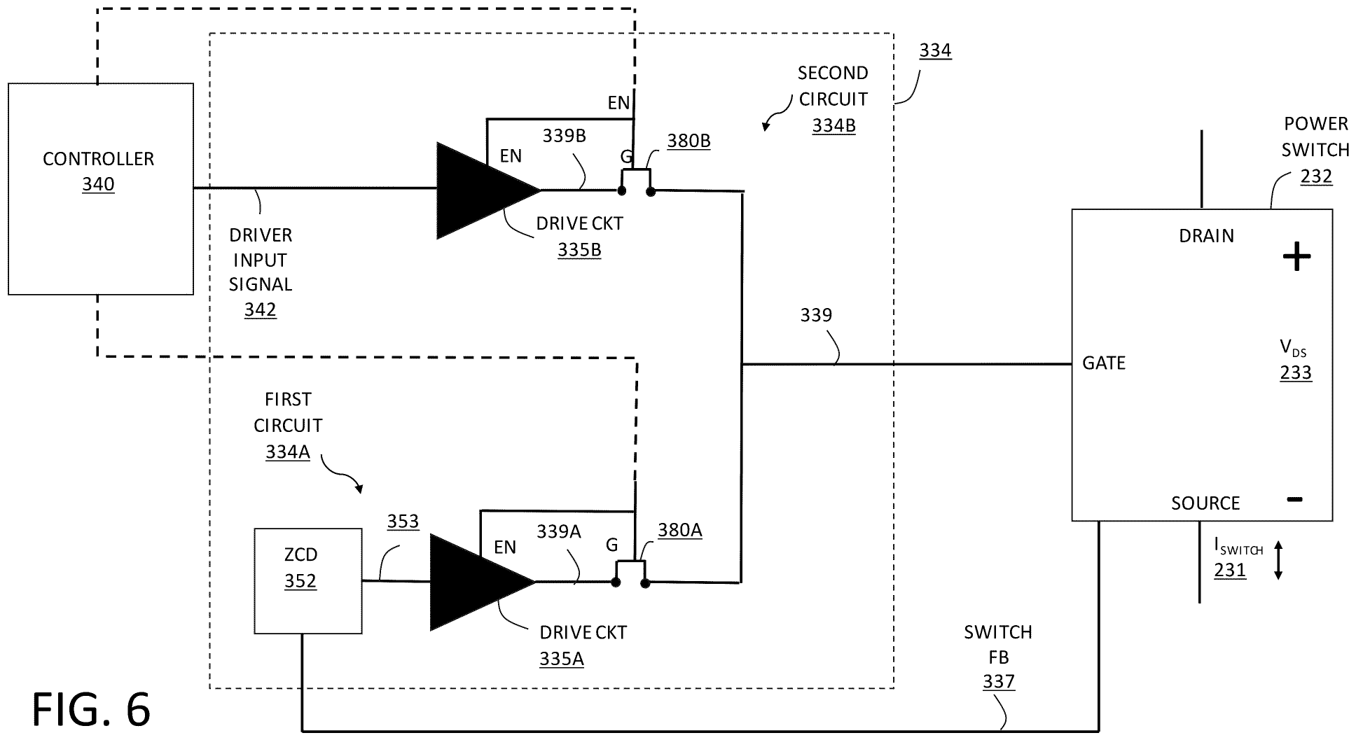

In some examples, driver circuitry 134 may be implemented as driver circuitry 234 depicted in FIG. 5, which uses a single drive circuit 235 configurable in the first mode and the second mode. In other examples, the driver circuitry 134 may be implemented as driver circuitry 334 depicted in FIG. 6, which includes a first circuit 334A configured to control secondary side switch 132 in the first mode, and a second circuit 334B configured to control secondary side switch 132 in the second mode.

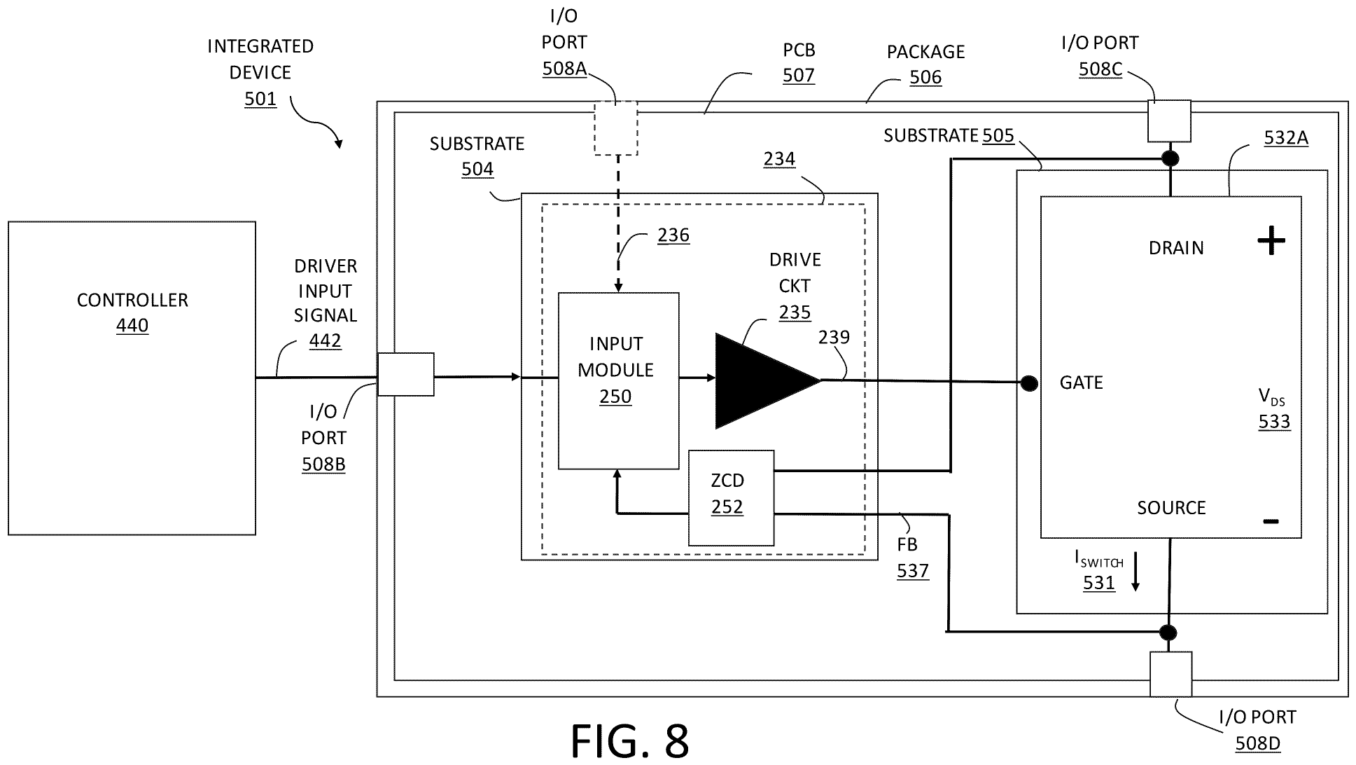

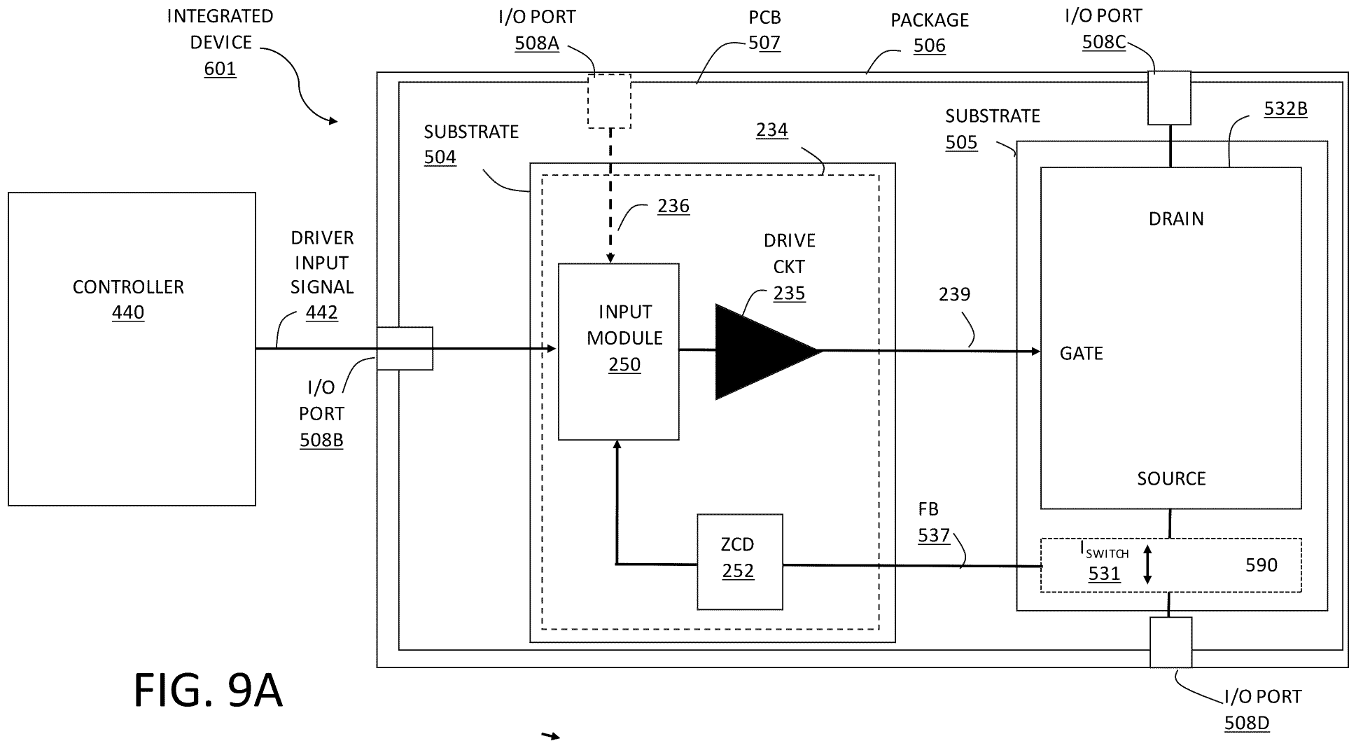

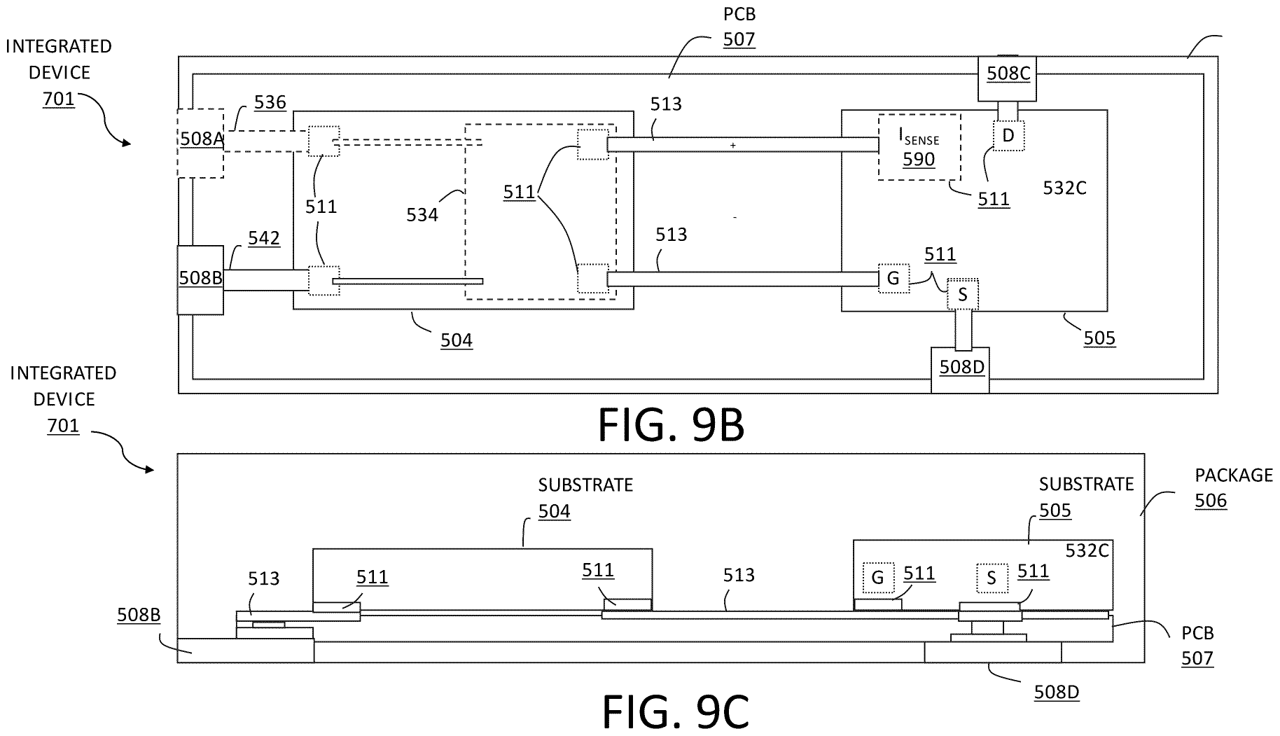

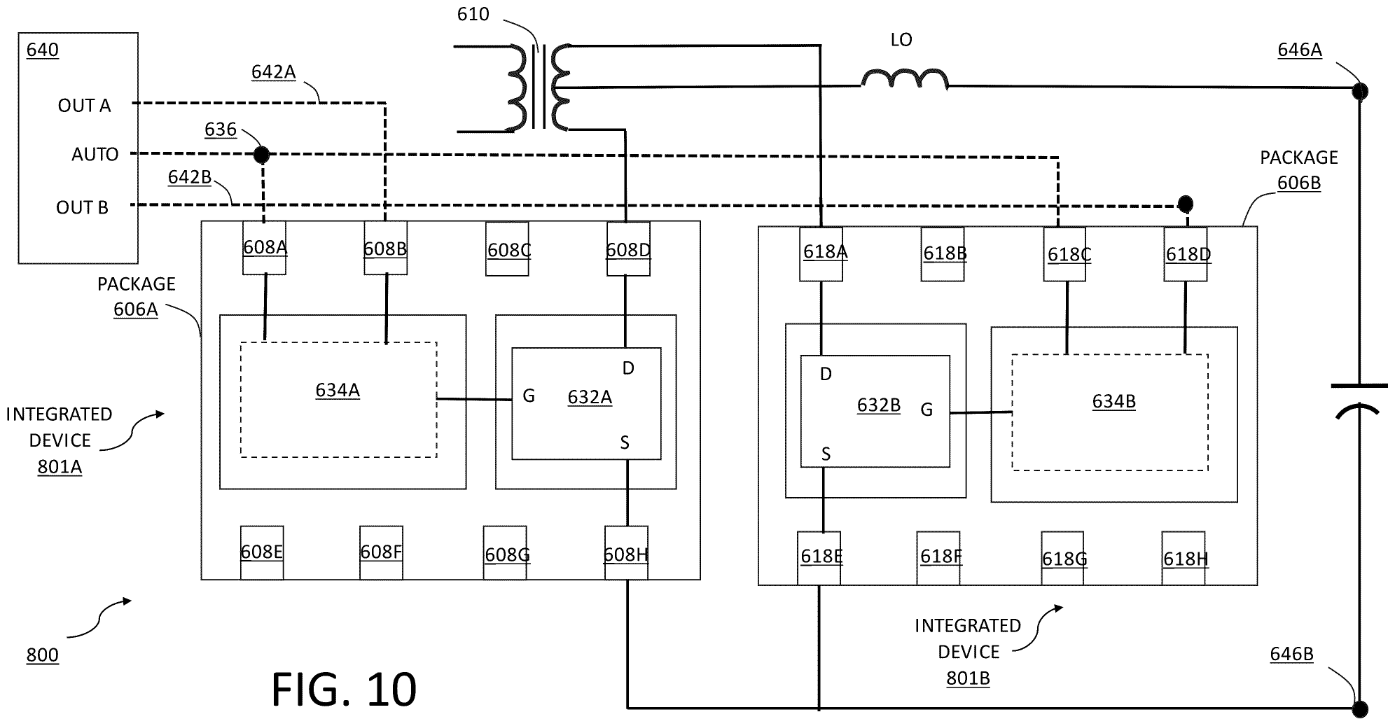

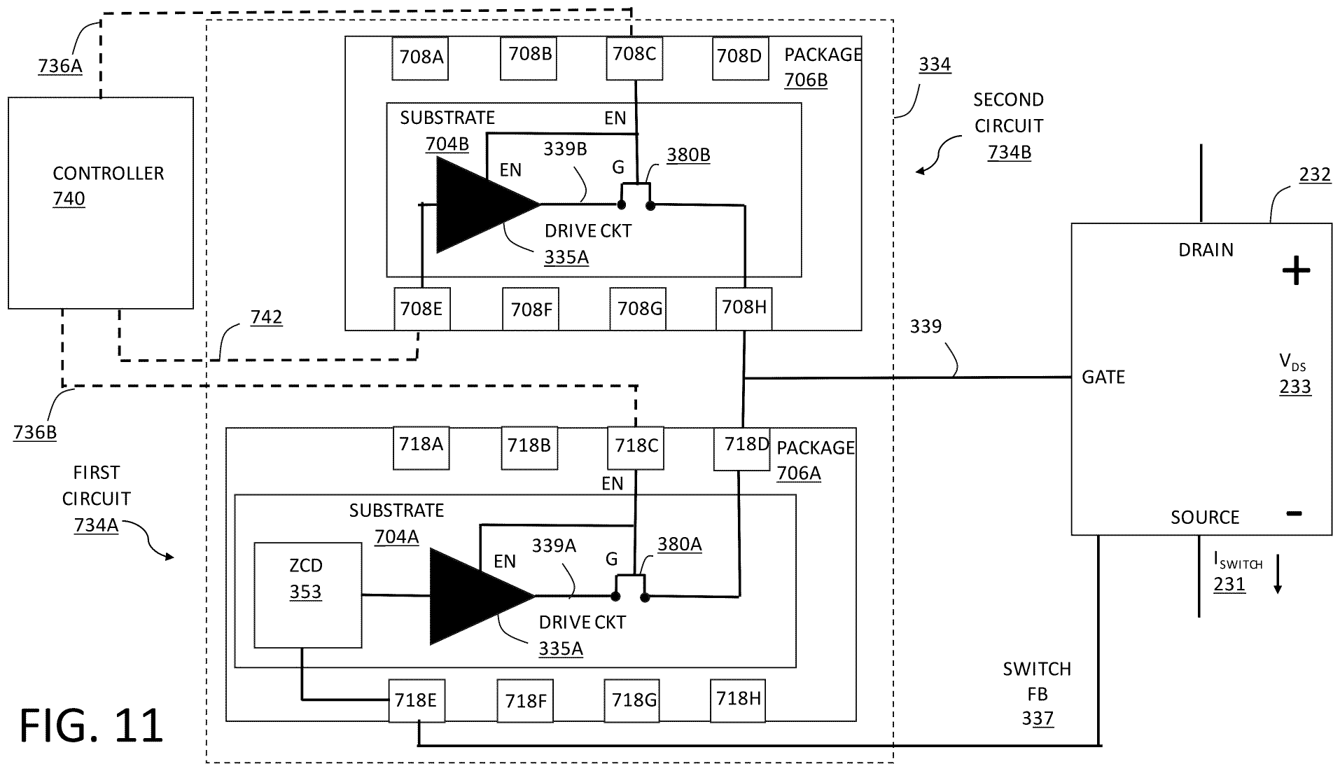

In some examples, the driver circuitry 234, and 334 may be used to control a power switch 232 as shown in FIGS. 5 and 6 that may be used as a secondary side switch 132 or a primary side switch 122 of a power converter 100, 200 as shown in FIGS. 1 and 2. In some examples, the power switch 232 may be implemented in a package 406A that has an I/O port 408A configured to receive a mode select input 236 of the driver circuitry 134 to operate in the first mode or the second mode. The package may also include a second I/O port 408B configured to receive the driver input signal 142. In some examples, the driver circuitry 134 may be housed in a package 506 with a power switch 532A as an integrated device 501 as shown in FIG. 8. In some examples, an integrated device 601 may include a power switch 532B with an integrated current sense circuit 590, as shown in FIG. 9A. In some examples, the power switch 532B may be a laterally arranged power switch 532C coupled to the driver circuitry 134 by laterally arranged traces 513 as shown in FIGS. 9B and 9C. In some examples, the integrated devices 501, 601, 701 shown in FIGS. 8 and 9A-C may be implemented as secondary side switches 132 coupled to a secondary winding of a transformer 610 as shown in the example of FIG. 10, in other examples not depicted the integrated devices 501, 601, 701 may also be implemented as primary side switches 122. In some examples, the driver circuitry 134 may be implemented as driver circuitry 334 depicted in FIG. 6, with respective first and second circuits 734A, 734B housed implemented in separate substrates each housed in discrete packages 706A, 706B, as shown in FIG. 11.

FIG. 2 is a block diagram that depicts one example of a bi-directional power converter 200 according to some embodiments. According to the FIG. 2 example, the converter 200 is a buck-boost converter that utilizes configurable driver circuitry 134A and 134B to drive respective switches 132A and 132B coupled to a secondary side of a transformer 110 to transfer energy between a high-voltage (HV) battery 101 at the primary side of the transformer 110 and a low-voltage (LV) battery 102 at the secondary side of the transformer 110. The buck-boost converter 200 shown in FIG. 2 is only one example of a power converter topology that may implement configurable driver circuitry 134 as described. In other examples, the configurable driver circuitry 134 may be used with other isolated DCDC converter topologies such as a flyback converter or a resonant half-bridge converter. In still other examples, the configurable driver circuitry 134 may be used with non-isolated DCDC converter topologies to support bi-directional energy transfer.

According to the example converter of FIG. 2, converter 200 includes a plurality of primary side power switches 122A-122D coupled in a full-bridge between the HV battery 101 and the primary winding of the transformer 110. A first side of the transformer 110 secondary side winding is coupled to a drain of a first secondary side switch 132A, and a second side of the transformer 110 secondary side winding is coupled to a drain of a second secondary side switch 132B. A LV battery 102 includes a first terminal coupled to a center-tap of the secondary side winding through an inductor L1, and a second terminal coupled to the source of each secondary side switch 132A, 132B through resistor R. The controller 140 is also coupled to the source of each secondary side switch 132A, 132B and the ground reference through the resistor R to enable the measurement of a load current across LV battery 102 as system feedback 144 to controller 140.

As depicted in the example of FIG. 2, converter 200 is configured to transfer energy bidirectionally between a high voltage HV battery 101 at a primary side of transformer 110 and a low voltage LV battery 102 at a secondary side of transformer 110. The example of FIG. 2 is provided for exemplary purposes only. In other examples not depicted, converter 200 may be configured to transfer energy bidirectionally between a low voltage LV battery at the primary side of transformer 110, and a high voltage HV battery at the secondary side of the transformer 110. In still other examples, converter 200 may be configured to transfer energy bidirectionally between batteries at the same voltage level, for example between a first high voltage battery at the primary side of the transformer and a second high voltage battery at the secondary side of the transformer 110, or between low voltage LV batteries coupled to the respective primary and secondary sides of the transformer 110. The description of the respective batteries herein as high or low voltage is provided for exemplary purposes only. The converter 200 depicted in FIG. 2 may be configured to transfer energy bidirectionally between any energy sources, such as batteries, that operate at any voltage level.

The buck-boost converter 200 depicted in FIG. 2 is configured to operate bi-directionally. For example, in a buck mode, converter 200 is operable to transfer energy from the HV battery 101 to the LV battery 102 in the first direction 164 depicted in FIG. 1. In the buck mode, the controller 140 controls the primary side switches 122A-122D to switch in pairs with a defined duty cycle to transfer energy through the windings of the transformer 110.

In the buck mode, the secondary side driver circuitry 134A, 134B are each configurable to operate in a first mode (e.g., via a mode select input 136A, 136B). When operated in the first mode, the secondary side driver circuitry 134A, 134B controls secondary side switches 132A, 132B to turn off when or slightly before a current through the respective secondary side switches 132A, 132B crosses zero. For example, the secondary side driver circuitry 134A, 134B may turn off the switches based on switch feedback 137A, 137B from the respective secondary side switches 132A, 132B, which may include a measured current I_{SWITCH} 131 through or measured voltage across the respective secondary side switches 132A, 132B. In the first mode, the secondary side driver circuitry 134A, 134B operates independent of any external control signal (e.g., from a controller 140) to turn off the secondary side switches 132A, 132B.

The buck-boost converter 200 is also operable in a boost mode. In the boost mode, the converter 200 transfers energy from the LV battery 102 to the HV battery 101 in the second direction 166 depicted in FIG. 1. In the boost mode, controller 140 controls secondary side switches 132A, 132B to switch with a defined duty cycle to transfer energy through the transformer 110. In the boost mode of converter 100, secondary side drive circuitry 134A, 134B are operated the second mode to drive the secondary side switches 132A, 132B to turn on and turn off based on driver input signals 142A, 142B from controller 140. In some examples, in the boost mode, the controller 140 also controls at least some of the primary side switches 122A-122D synchronously with secondary side switches 132.

As shown in FIG. 1, the primary side switches 122A-122D also includes primary side driver circuitry 124A-124D. In some examples, the primary side driver circuitry 124A-124D is operable to turn on and off the primary side switch 122 based on a driver input signal 121A-121D from controller 140, regardless of a direction of energy transfer.

In other examples, the primary side driver circuitry 124A-124D is also configurable to operate in the first and second modes described herein. In some such examples, the primary side driver circuitry 124A-124D is configurable to be operated in the first or second mode using a mode select input 126A-126D of the primary side driver circuitry 124A-124D. In other examples, the primary side driver circuitry 124A-124D may be self-configurable in the first mode or the second mode based on a detected direction of current flow through the primary side switches 122A-122D.

The buck-boost converter 200 depicted in FIG. 2 may offer significant advantages in comparison to traditional power converters for applications involving input and output voltages that vary by a wide range. For example, by incorporating configurable drive circuitry 134A, 134B (and/or 122A, 122B in some embodiments), the buck-boost converter depicted in FIG. 2 may be operable to transfer energy bi-directionally between HV battery 101 and LV battery 102 efficiently across a wide range of input and output voltages, without requiring separate converters to support each direction of power flow between the HV battery 101 and the LV battery 102. Accordingly, sharing of critical energy resources between isolated battery systems 101, 102 may be implemented with less complexity and at a lower cost than traditional systems that use multiple converters for bi-directional charging.

FIG. 3 is a block diagram depicting one example of a vehicle power system 300 according to some embodiments. The system 300 includes a high voltage HV battery 101, which may be used to store energy to, for example, to drive an electric motor of a vehicle. The HV battery 101 is configured to store and supply energy at relatively high voltage levels. For example, the HV battery 101 may be configured to store and supply energy at anywhere from several tens of volts to hundreds of volts, and in some cases more than a thousand or thousands of volts.

Terminals of the HV battery 101 are coupled through a switch to an on-board charger 311, which operates to convert alternating current (AC) energy from the AC power grid 321 to Direct Current (DC) energy suitable to charge HV battery 101. The HV battery 101 is coupled to the LV battery 101 through a DCDC converter 320, which includes a primary side 120 coupled to a secondary side 130 via a transformer 110. The LV battery 102 is used to store and supply energy at relatively low voltage levels in comparison to the HV battery 101. For example, the LV battery 102 may supply energy at voltage levels up to 12 volts. The LV battery 102 may be used by lower voltage electrical systems of the vehicle that operate using 12 volts or less than 12 volts as a power supply.

In an electric or hybrid vehicle, DCDC converter 320 may be operated to transfer energy from the HV battery 101 to the LV battery 102 to charge the LV battery 102. In some examples, it may be beneficial to enable bi-directional charging of the HV battery 101 using energy stored by the LV battery 102. For example, enabling the LV battery 102 to charge the HV battery when the HV battery 101 charge is low and at risk of being depleted may beneficially extend a range of a vehicle.

As mentioned above, in some examples, traditional vehicle electrical systems may employ separate DCDC power converters to support bi-directional charging between vehicle battery systems. As described above with respect to the examples of FIGS. 1 and 2, system 310 may incorporate a DCDC converter 320 with driver circuitry 134 configurable in a first mode or a second mode, which enables DCDC converter 320 to operate with high efficiency in both charging directions, without incorporating separate DCDC converters to support each charging direction like traditional bi-directional charging systems.

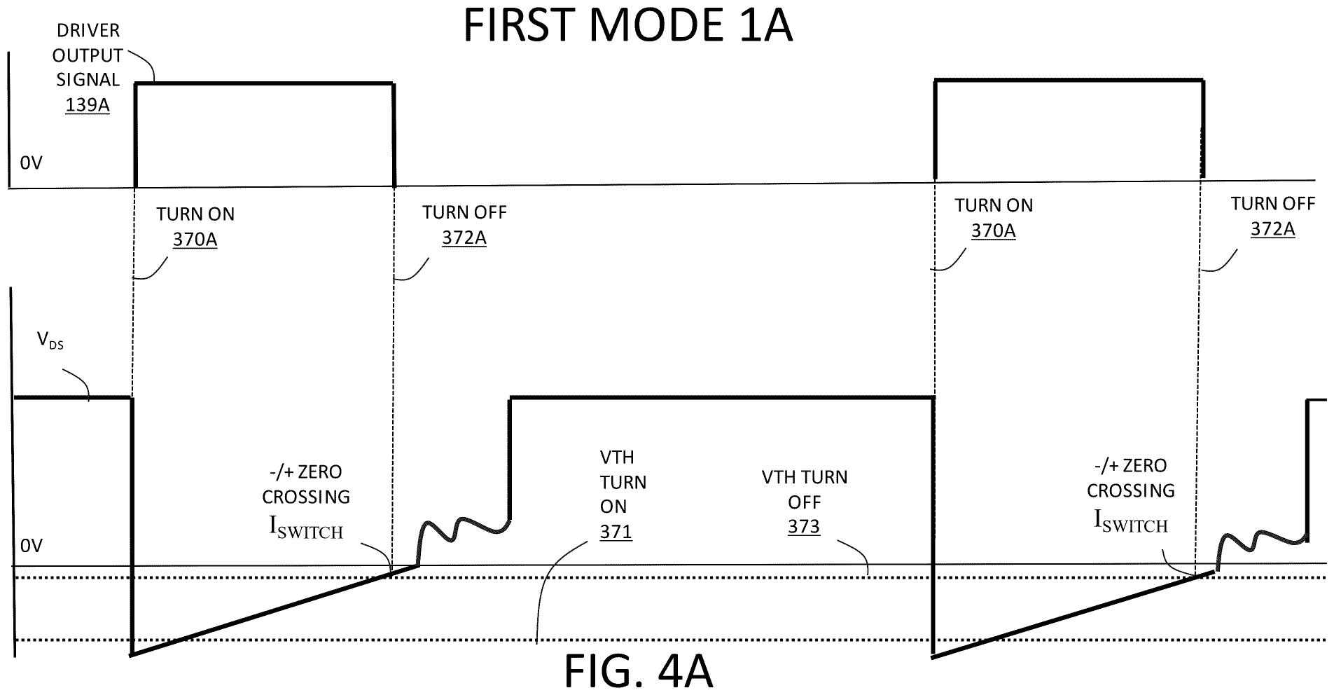

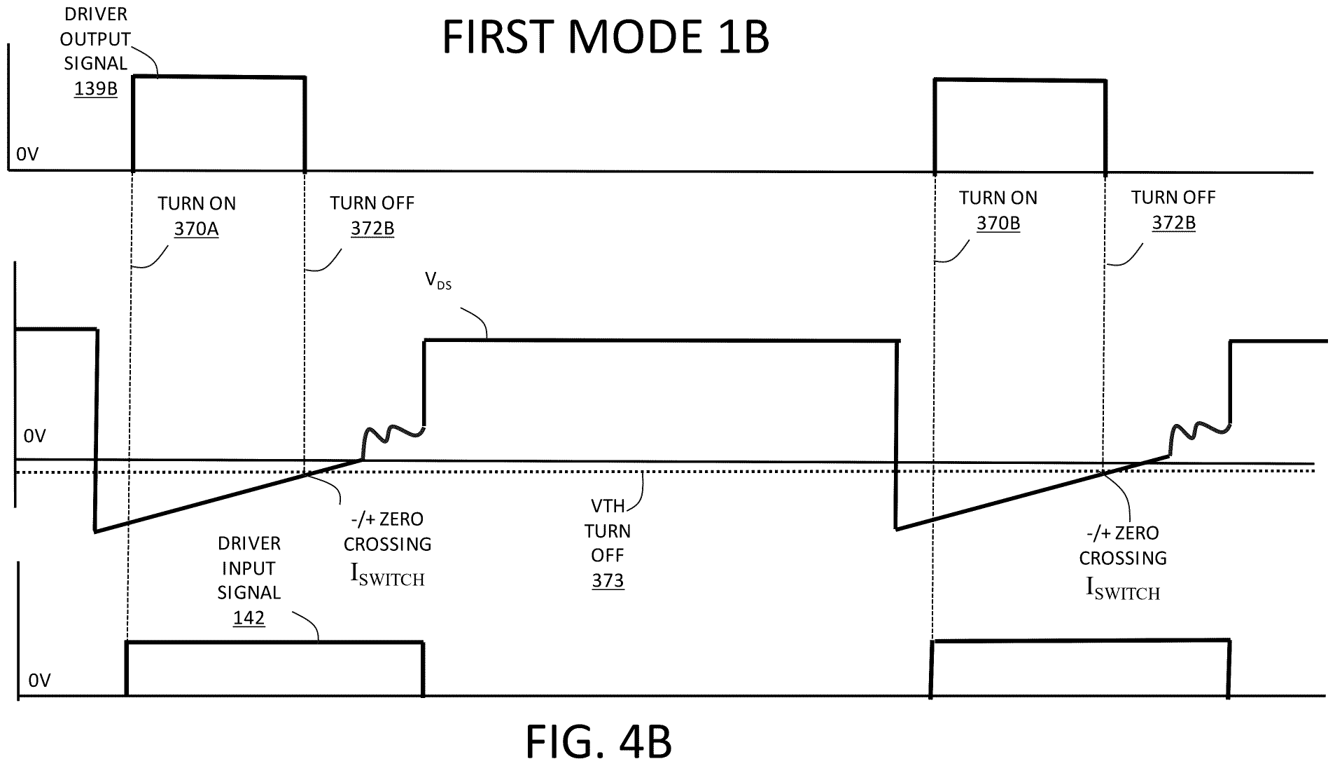

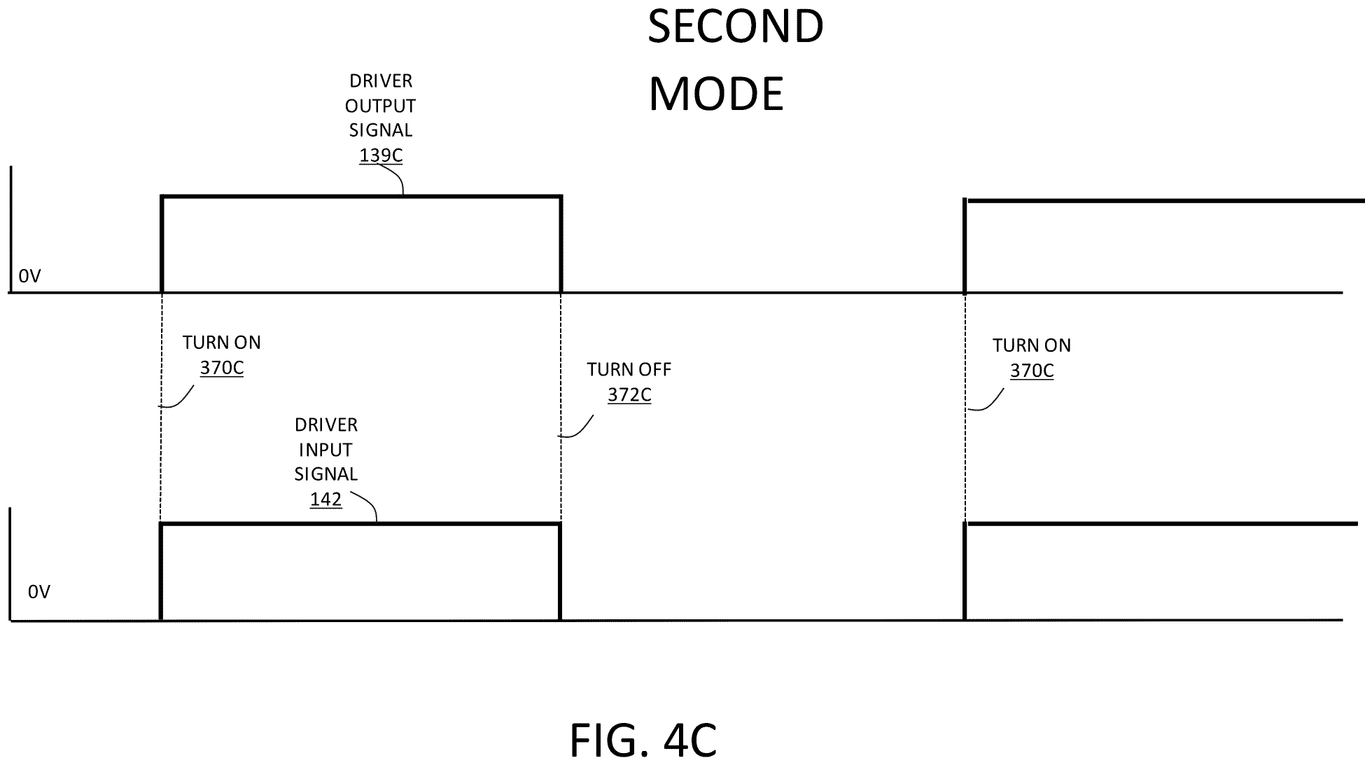

Referring back to FIG. 1, driver circuitry 134 is configurable to operate in a first mode in to turn the secondary side switch 132 off when, or shortly before a current through the secondary side switch 132 crosses zero, and a second mode in which the driver circuitry is operated to turn on and to turn off based on a driver input signal 142. FIGS. 4A and 4B are timing diagrams that depict driver circuitry 134 operated the first mode according to different embodiments 1A and 1B, and FIG. 4C depicts driver circuitry 134 operated in the second mode according to some embodiments. The timing diagrams shown in FIGS. 4A-4C are described as generated by driver circuitry 134 to control a secondary side switch 132 as depicted in FIG. 1. In other examples, the timing diagrams shown in FIGS. 4A-4C may be generated by driver circuitry 124 to control a primary side switch 122, as also depicted in FIG. 1.

FIG. 4A depicts a driver output signal 139A generated by the driver circuitry 134 operated in a first mode, to control the secondary side switch 132 based switch feedback 137 that represents the current I_{SWITCH} 131 through the secondary side switch 132. In the example of FIG. 4A, the driver circuitry 134 uses a measured drain source voltage V_{DS} of the secondary side switch 132 as switch feedback 137. In other examples not depicted, the driver circuitry 134 uses a direct measurement of the current I_{SWITCH} 131 as switch feedback 137 to, for example when the secondary side switch 132 (or primary side switch 122) includes an integrated current sense circuit.

FIG. 4A depicts driver circuitry operated in the first mode, according to an embodiment 1A in which the driver circuitry 134 controls the secondary side switch 132 to turn on and to turn off based switch feedback 137, including to turn off when or slightly before the current I_{SWITCH} 131 crosses zero. FIG. 4B depicts an alternative embodiment 1B of the first mode in which the driver circuitry 134 controls the secondary side switch 132 to turn off when or slightly before the current I_{SWITCH} 131 crosses zero like in the embodiment 1A, and controls the secondary side switch 132 to turn based on a driver input signal 142 from a controller 140.

FIG. 4A depicts a driver output signal 139A generated by the driver circuitry 134 operated in a first mode 1A according to some embodiments. According to the example of FIG. 4A, in the first mode 1A, the driver circuitry 134 uses switch feedback 137 that reflects the current I_{SWITCH} 131 through the secondary side switch 132, to turn on the secondary side switch 132 at time turn on times 370A and turn off the secondary side switch 132 at turn off times 372A. For example, the measured voltage V_{DS} is decreasing in magnitude and crosses a threshold V_{TH TURN ON} that indicates that the current I_{SWITCH} 131 has begun flowing through a body diode of the secondary side switch 132 (e.g., I_{SWITCH} 131 increases from zero to positive, or from zero to negative, driver circuitry 134 causes driver output signal 139A to transition high, to turn on secondary side switch 132 at on times 370A. As also shown in FIG. 4A, if a minimum on time has elapsed and the measured voltage V_{DS} is increasing in magnitude and crosses a threshold VTH TURN OFF that indicates the current I_{SWITCH} 131 will cross zero (e.g., from negative to positive −/+), driver circuitry 134 causes driver output signal 139A to transition low, to turn off the secondary side switch 132 at off times 372A.

FIG. 4B depicts a driver output signal 139B generated by the driver circuitry 134 operated in a first mode according to some embodiments. FIG. 4B illustrates an alternative embodiment 1B of the first mode, in which driver circuitry 134 is configured to turn off the secondary side switch 132 when or slightly before the current_{SWITCH} 131 through the power switch 132 crosses zero, like the example of FIG. 4A.

As shown in FIG. 4B, like the example of FIG. 4A, the driver circuitry 134 is configured generate a driver output signal 139B that turns off the power switch 132 at a time 372B based on when a current I_{SWITCH} 131 through the power switch 132 crosses zero (e.g., a zero crossing detection from positive to negative) based on comparing the measured voltage V_{DS} to the threshold V_{TH TURN OFF} as described above with respect to FIG. 4A.

Unlike the example of FIG. 4A, in the embodiment 1B shown in FIG. 4B, the driver output signal 139B is not switched on based on determining when the current I_{SWITCH} 131 starts to flow through the body diode of the secondary side switch. Instead, in the first mode 1B, the driver circuitry 134 turns on secondary side switch 132 at on times 370B, in response to low to high transitions of the driver input signal 142. In some examples, driver circuitry 134 configured to operate in the first mode embodiment 1B depicted in FIG. 4B may be less complex and/or costly to manufacture, since only a single comparator may be needed to detect positive to negative +/− crossings of the current I_{SWITCH} 131, to turn off the power switch 132.

FIG. 4C depicts a driver output signal 139C generated by the driver circuitry 134 operated in a second mode, to control the secondary side switch 132 to turn on and to turn off based on a driver input signal 142 from a controller 140 according to some embodiments. As shown in FIG. 4C, the driver input signal 142 causes the driver output signal 139C to transition high at turn on times 370C, to turn on the secondary side switch 132. As also shown in FIG. 4C, the driver input signal 142 causes the driver output signal 139C to transition low at turn off times 372C, to turn off the secondary side switch 132.

FIG. 5 is a block diagram that depicts driver circuitry 234 configured to operate in a first mode (e.g., as depicted in FIG. 4A or 4B), or a second mode (e.g., as depicted in FIG. 4C) according to some embodiments. Driver circuitry 234 may be used to control a power switch 232, which may be used as a secondary side switch 132 and/or a primary side switch 122 of a power converter 100, 200 as shown in the examples of FIGS. 1 and 2.

According to the examples of FIG. 5, the driver circuitry 234 includes a single drive circuit 235, which amplifies a low power driver control signal 243 at an input to output a high current driver output signal 239 to control a gate of the power switch 232. The drive circuit 235 is configured to generate a driver output signal 239 with sufficient current to turn on and turn off the power switch 232.

As shown by the dashed-line arrow in FIG. 5, driver circuitry 234 optionally includes a mode select input 236 used to control the driver circuitry 234 in a first or second mode by controlling the driver control signal 243 input to the drive circuit 235, for example based on a direction of current flow through the power switch 232 and/or a direction of energy transfer.

In other examples, driver circuitry 234 does not include the mode select input 236, and is self-configurable to operate in the first mode or the second mode based on a direction of current flow through the power switch 232, for example based on switch feedback 237, which may be a measured voltage V_{DS} 233 across the power switch 232, or a measured current I_{SWITCH} 231 through the power switch 232 in examples where power switch 232 includes a current sense circuit.

For example, when implemented as a secondary side switch 132 as depicted in FIG. 1, the driver circuitry 232 may be self-configurable to operate in the first mode when the current I_{SWITCH} 231 through the power switch 232 flows in a first direction 260 from the source of the power switch 232 to a drain of the power switch 232, and in the second mode when the current I_{SWITCH} 231 flows in a second direction 262 from the drain the power switch 232 to the source of the power switch 232. As another example, when implemented as a primary side switch 132 as depicted in FIG. 1, the driver circuitry 232 may be similarly self-configurable to operate in the first mode when the current I_{SWITCH} 231 through the power switch 232 flows in the first direction 260 from the source of the power switch 232 to the drain of the power switch 232, and in the second mode when the current I_{SWITCH} 231 flows in the second direction 262 from the drain of the power switch 232 to the source of the power switch 232.

As shown in the FIG. 5 example, driver circuitry 234 includes an input interface 250 and a zero crossing detector (ZCD) 252. The ZCD 252 is coupled to receive switch feedback 237 from the power switch 232, which may be a measured voltage V_{DS} 233 across the power switch 232 in some embodiments, or a measured current I_{SWITCH} 231 through the power switch 232, for example where power switch 232 includes an integrated current sense circuit (not shown in FIG. 5). The ZCD 252 may include one or more comparators configured to monitor the switch feedback 237 and generate a ZCD control signal 253 in response to the current I_{SWITCH} 231, such that the power switch 232 is turned off when or slightly before the current I_{SWITCH} 231 through the power switch 232 crosses zero, and turned on when the current I_{SWITCH} 131 has begun flowing through a body diode of the secondary side switch 132 (e.g., I_{SWITCH} 131 changes from zero to positive, or from zero to negative).

For example, where ZCD 252 is configured to the monitor a voltage V_{DS} 233 across the power switch 232, ZCD 252 may include a first comparator configured to transition the ZCD control signal 253 low when, after a minimum turn on time, a measured voltage V_{DS} 233 increases above a turn off threshold V_{TH TURN OFF} 373 as shown in the example of FIG. 4A. According to another example, ZCD 252 may include a second comparator configured to transition the ZCD control signal 253 high when a measured voltage V_{DS} 233 decreases below a turn on threshold V_{TH TURN ON} 371 as also shown in FIG. 4A. According to still other examples, such as if power switch 232 includes an integrated current sense circuit (not shown in FIG. 5), ZCD 252 may include comparator(s) configured to identify respective zero crossings of the current I_{SWITCH} 231 based on a directed measurement of the current I_{SWITCH} 231. The input interface 250 is coupled to receive the ZCD control signal 253 from the ZCD 252, as well as a driver input signal 242 from a controller 140 as shown in FIG. 1, and control the driver circuitry 234 in the first mode or the second mode using the ZCD control signal 253 and the driver input signal 242. For example, to operate in the first mode 1A shown in FIG. 4A, the input interface 250 may decouple the driver input signal 242 from the driver control signal 243 and couple the ZCD control signal 253 to the drive circuit 235 as the driver control signal 243, which causes the driver circuitry 234 to turn the power switch 232 on and off based on the ZCD control signal 253. According to this example, to operate in the second mode shown in FIG. 4C, the input interface 250 couples the driver input signal 242 to drive circuit 235 as the driver control signal 243 and decouples the ZCD control signal 253 from the drive circuit 235. In this manner, input interface 250 operates as a multiplexer that couples either the driver input signal 242 or the ZCD control signal 253 to the drive circuit 253 as the driver control signal 243 to operate in the respective first and second modes.

In some examples, the input interface 250 may optionally be configured to enable or disable the ZCD 252 through an enable input 254 of the drive circuit 235. According to these examples, the input interface 250 disables the ZCD 252 in the second mode to conserve energy. In some examples, such as if the power switch 232 includes an optional current sense circuit, the input interface 250 may also disable the current sense circuit in the second mode.

According to other examples, the driver circuitry 234 depicted in FIG. 5 may operate in the first mode 1B depicted in FIG. 4B. According to this example, in the first mode 1B, the input interface 250 couples the driver input signal 242 from controller 240 to the drive circuit 235, such that the driver input signal 242 transitions the driver control signal 243 high and turns the power switch 232 on at turn on times 370A and 370B. According to this example, in the first mode 1B, the input interface 250 interrupts the driver input signal 242 to turn off at time 372B in response to high to low transitions in the ZCD control signal 253, which forces the driver output signal 239 low when or slightly before the current I_{SWITCH} 231 through the power switch 232 crosses zero. In this manner, in the first mode 1B, the input interface 250 alternates between coupling transitions of the driver input signal 242 to turn on the power switch 232, and transitions of the ZCD control signal 253 to turn off the power switch 232. Accordingly, in the first mode 1B, the input interface 250 is operable to turn on the power switch 232 on based on the driver input signal 242 from a controller 140, and to turn off the power switch 232 when, or slightly before the current I_{SWITCH} 231 through the power switch 232 crosses zero. According to these examples, to operate in the second mode, the input interface 250 blocks the ZCD control signal 253 from interrupting the driver input signal 242, and in some embodiments disables one or more of the ZCD 252 and an optional integrated current sense circuit as described above.

According to examples where driver circuitry 234 is configured to operate in the first mode 1B depicted in FIG. 4B, the ZCD 252 may only include a single comparator as described above configured to transition the ZCD control signal 253 low when a measured voltage V_{DS} 233 increases above a turn off threshold V_{TH TURN OFF} 373. According to these examples, ZCD 252 may not include a second comparator configured to transition the ZCD control signal 253 high when a measured voltage V_{DS} 233 that is decreasing falls below a turn on threshold V_{TH TURN ON} 371 as described above, which may reduce a cost and/or complexity to implement driver circuitry 234. In still other examples, such as where power switch 232 includes an integrated current sense circuit (not shown in FIG. 5), ZCD 252 includes only a single comparator identify negative to positive (−/+) zero crossings of the measured current I_{SWITCH}, to turn off the power switch 232 when or slightly before the current I_{SWITCH} crosses zero.

FIG. 6 is a block diagram depicting another example of driver circuitry 334 configured to be operable in a first mode or a second mode according to some embodiments. As shown FIG. 6, the driver circuitry includes a first circuit 334A and a second circuit 334B, each of which are coupled to control a gate of a power switch 232 with a driver output signal 339. The driver circuitry 334 may be used to control the power switch 232, which may be used as a secondary side switch 132 and/or a primary side switch 122 of a power converter 100, 200 as shown in the examples of FIGS. 1 and 2.

According to the example of FIG. 6, the first circuit 334A is configured, in the first mode, to turn the power switch 232 on and turn the power switch 232 off based when, or slightly before, the current I_{SWITCH} 231 through the power switch 232 will cross zero as depicted in the example of FIG. 4A. The first circuit 334A includes a first drive circuit 335A configured to amplify a ZCD control signal 353 from a zero crossing detector (ZCD) 352 to output a first driver output signal 339A that causes power switch 232 to switch based on the ZCD control signal 353.

According to the example of FIG. 6, the ZCD 352 includes one or more comparators configured to monitor the switch feedback 337 to determine when the current I_{SWITCH} 231 through the power switch 232 will cross zero, and generate the ZCD control signal 353 to turn on or turn off the power switch 232 in response. For example, where ZCD 252 is configured to the monitor a voltage VDS 233 across the power switch 232 as depicted in FIG. 4A, ZCD 352 may include a first comparator configured to transition the ZCD control signal 353 high when a measured voltage VDS 233 increases above a turn off threshold V_{TH TURN OFF} 373 as shown in FIG. 4A. According to this example, ZCD 252 may include a second comparator configured to turn on the ZCD control signal 353 when a measured voltage VDs 233 that is decreasing (e.g., from positive to negative) falls below a turn on threshold V_{TH TURN ON} 371, as also shown in the FIG. 4A example. In other examples, ZCD 252 may instead include comparator(s) to identify zero crossings based on a measured current I_{SWITCH} 231, for example where power switch 232 includes an integrated current sense circuit.

According to the example of FIG. 6, the second circuit 334B is configured to, in the second mode, control the power switch 232 to turn on and turn off based on a driver input signal 342 from a controller 340. As shown in FIG. 6, the second circuit 334B includes a second drive circuit 335B configured to amplify the driver input signal 342 from the controller, and output a second driver output signal 339B to drive the power switch 232 to turn on and turn off based on the driver input signal 342.

As also shown in FIG. 6, each of the first and second circuits 334A and 334B are coupled to the power switch 232 gate through a respective disconnect switch 380A, 380B that operate as an output interface of the driver circuit 334. Each of the disconnect switches 380A, and 380B may be relatively small control transistors in comparison to power switch 232, for example MOSFETS implemented in Complimentary Metal Oxide Semiconductor (CMOS) or similar technology that have a lower voltage rating than power switch 232. According to the example of FIG. 6, a first driver output signal 339A of the first drive circuit 335A is coupled through the first disconnect switch 380A to a gate of the power switch 232. As also shown in FIG. 6, a second driver output signal 339B of the second drive circuit 335B is coupled through the second disconnect switch 380B to the gate of the power switch 232.

As shown in FIG. 6, a control terminal of each of the disconnect switches 380A, 380B is coupled to controller 340, which controls the driver circuitry 332 to operate in the first mode and the second mode via the disconnect switches 380A, 380B. For example, to operate in the first mode, the controller 340 generates a first control signal to cause the first disconnect switch 380A to couple the first driver output signal 339A to the gate of power switch 232 as a driver output signal 339, and generates a second control signal (or an inverted version of the first control signal) to cause the second disconnect switch 380B to decouple the second driver output signal 339B from the gate of power switch 232, so that the second driver output signal 339B does not interfere with the first drive output signal 339A to drive the power switch 232 in the first mode.

To operate in the second mode, the controller 340 generates a first control signal to cause the second disconnect switch 380B to couple the second driver output signal 339B to the gate of power switch 232 as a driver output signal 339, and generates a second control signal (or an inverted version of the first control signal) to cause the first disconnect switch 380A to decouple the first driver output signal 339A from the gate of power switch 232, so that the first drive output signal 339A does not interfere with the second driver output signal 339B to drive the power switch 232 in the second mode.

As also shown in FIG. 6, in some examples, each of the first and second drive circuits 335A and 335B may include an enable input configured to enable or disable the respective drive circuits 335A and 335B, for example to enable the respective drive circuits 335A and 335B to amplify a low voltage control signal to generate respective driver output signals 339A and 339B, or disable the respective drive circuits 335A and 335B by disconnecting them from a power source. According to these examples, the enable input of each drive circuits 335A and 335B may be coupled to the control terminals of the respective disconnect switches 380A, 380B, such that a control signal to decouple a respective drive circuits 335A, 335B from the power switch 232 gate also disables the respective drive circuits 335A and 335B to conserve energy.

According to these examples, when the controller 340 generates a first control signal to cause the first disconnect switch 380A to couple the first drive circuit 335A to the gate of power switch 232, the control signal also enables the first driver to amplify the ZCD control signal 353 to generate the second driver output signal 339B. In the first mode, the controller 340 generates a second control signal (or an inverted version of the first control signal) to cause the second disconnect switch 380B to decouple the second driver output signal 339B from the gate of the power switch 232, the second control signal also disables the drive circuit 335B, so that drive circuit 335B does not consume power in the first mode.

Similarly, in the second mode, when the controller 340 generates a first control signal to cause the second disconnect switch 380B to couple the second drive circuit 335B to the gate of power switch 232, the first control signal also enables the second drive circuit 335B to amplify the driver input signal 342 from the controller 340.

In the second mode, when the controller 340 generates a second control signal (or an inverted version of the first control signal) to cause the first disconnect switch 380A to decouple the first driver output signal 339A from the gate of the power switch 232, the second control signal also disables the first drive circuit 335A via the enable input, so that the first drive circuit 335A does not consume power in the first mode.

Referring back to FIG. 1, a power converter 100 includes driver circuitry 134 configured to control secondary side switch 132 according to first and second modes. In some embodiments, the driver circuitry 134 may include driver circuitry 234 as shown in FIG. 5 with a single drive circuit 235 that is configurable to operate in the first mode or the second mode. In other examples, driver circuitry 134 may include driver circuitry 334 which includes multiple drive circuits 334A and 334B as shown in FIG. 6, including a first circuit 334A configured to control the power switch 132 in the first mode, and a second circuit 334B configured to control the power switch 132 in the second mode.

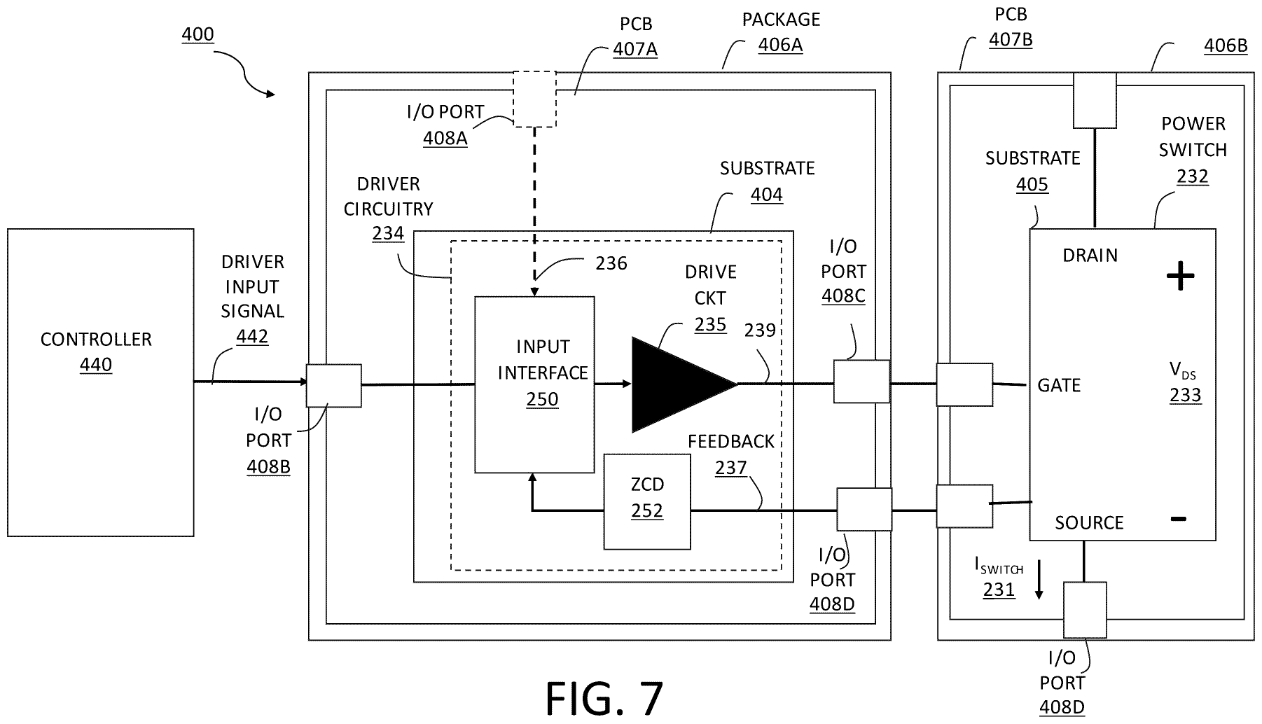

In some examples, a driver circuit 134 as shown in FIG. 1 may be implemented as part of a converter 100, 200 by coupling the driver circuit 134 to secondary side switch 132, as well as other system components. For example, the driver circuitry 134 may be housed in a package, and the secondary side switch 132 may be housed in a separate package and coupled to the driver circuit 134 as shown in FIG. 7. According to other examples, driver circuitry 134 may be integrated with and interconnected to the secondary side switch 132 in the same package, as an integrated device 501, as shown in FIG. 8. In some examples, an integrated device 601 includes a power switch 532B with an integrated current sense circuit 590 as shown in FIG. 9A. In some examples, an integrated device 701 includes a laterally arranged power switch 532C with an integrated current sense circuit 590 as shown in FIGS. 9B and 9C.

FIG. 7 is a block diagram that depicts one example of a device 400 that includes the driver circuitry 234 shown in the example FIG. 5 monolithically integrated in a substrate housed within a package 406A. In other examples not depicted, driver circuitry 334 depicted in FIG. 6 may similarly be monolithically integrated in a substrate that is housed in a package. For example, the respective first and second circuits 334A and 334B may be monolithically integrated with one another in a single semiconductor substrate housed in a package, implemented in separate substrates housed in the same package, or may be housed in separate packages as discrete components.

As shown in the FIG. 7 example, the device 400 includes driver circuitry 234 used to control a power switch 232, which may be used as a secondary side switch 132 and/or a primary side switch 122, of a power converter 100, 200 as shown in the examples of FIGS. 1 and 2. As shown in the example of FIG. 7, the driver circuitry 234 is implemented in a substrate 404, which may be a silicon based substrate. The substrate 404 is mounted on a printed circuit board (PCB) 407A, and coupled to I/O ports 408A-408D on the package 406A. In the FIG. 7 example, the power switch 232 is implemented in a substrate 405 housed in a second package 406B mounted on a second PCB 407B.

The package 406A includes a first I/O port 408A that is coupled to mode select input 436 of the driver circuit 234. The package 406A also includes a second I/O port 408B coupled to receive a driver input signal 442 from a controller 440. The package further includes a third I/O port 408C that couples a driver output signal 239 from the drive circuit 235 to a gate of the power switch 232 via an I/O port on the second package 406B. The package 406A further includes a fourth I/O port 408D that coupled to receive switch feedback 237 from the power switch 232. For example, the fourth I/O port 408D may be a pair of I/O ports coupled across a drain terminal and a source terminal of the power switch 232 via I/O ports on the power switch package 406B. In other examples, if power switch 232 includes an integrated current sense circuit housed in package 406B (not shown in FIG. 7), the fourth I/O port 408D may be coupled to receive a measured current sense signal from the power switch package 406B.

FIG. 8 is a block diagram that illustrates one example of an integrated device 501, which includes both a power switch 532A and drive circuity 234 configurable in a first mode and a second mode to control the power switch 532A according to some embodiments. The integrated device 501 depicted in FIG. 8 includes drive circuitry 234 depicted in FIG. 5, but may include drive circuitry 334 depicted in FIG. 6 in other embodiments. As shown in the FIG. 8 example, driver circuitry 234 is used to control a power switch 532A, which may be used as a secondary side switch 132 and/or a primary side switch 122 of a power converter 100, 200 as shown in the examples of FIGS. 1 and 2.

According to the example of FIG. 8, the integrated device 501 includes a single package 506 that houses the power switch 532A and the drive circuitry 234. For example, as shown in FIG. 8, the drive circuitry 234 is implemented in a first substrate 504 mounted on a printed circuit board (PCB) 507 in package 506, and the power switch 532A is implemented in a second substrate 505 different than the first substrate 504 mounted adjacent to the first substrate 504 in the package 506. In the FIG. 8 example, a driver output signal 239 of the driver circuitry 234 is coupled to a gate of the power switch 532A within the package 506.

As also shown in the FIG. 8 example, the driver circuitry 234 is coupled within the package to the drain and source terminals of the power switch 532A. As also shown in FIG. 8, the integrated device package 506 further includes a plurality of I/O ports 508A-508D configured to be coupled to other components of a converter 100 as depicted in the examples of FIGS. 1 and 2.

As shown in FIG. 8, the package 506 includes a first I/O port 508A coupled to the mode select input 236 of the driver circuitry, which is coupled to input interface 250 in the FIG. 8 example. As also shown in FIG. 8, the package 506 also includes a second I/O port 508B coupled to receive the driver input signal 442 from a controller 440. As also shown in the FIG. 8 example, the package 506 further includes I/O ports 508C and 508D, which are coupled to the drain and source terminals of the power switch 532A, respectively to measure the voltage VDs 533 across the switch 532A as switch feedback 537. The I/O ports 508A and 508B may be used to couple other components of a power converter 100 to the power switch 532A. For example, the I/O port 508C may be used to couple a drain of the power switch 532A to a secondary winding of a transformer 110 as depicted in the examples of FIGS. 1 and 2. As another example, the I/O port 508D may be used to couple a source of the power switch 532A to a load and/or a ground reference, as also shown in the example of FIG. 2.

FIG. 9A is a block diagram that illustrates one example of an integrated device 601, which includes both a power switch 532B and drive circuity 234 configurable in a first mode and a second mode to control the power switch 532B according to some embodiments. FIGS. 9B and 9C depict top down and side views, respectively, of an integrated device 701 with a laterally arranged power switch 532C implemented in a package 506 according to some embodiments. As shown in the FIG. 9A-9C examples, driver circuitry 234 is used to control a power switches 532A-532C, which may be used as a secondary side switch 132 and/or a primary side switch 122, of a power converter 100, 200 as shown in the examples of FIGS. 1 and 2.

According to the example of FIG. 9A, the integrated device 601 includes a single package 506 that houses a power switch 532B and drive circuitry 234 housed within the single package 506. The integrated device 601 includes drive circuitry 234 depicted in FIG. 5, but may include drive circuitry 334 depicted in FIG. 6 in other embodiments. The integrated device 601 differs from integrated device 501 shown FIG. 8 in that the power switch 532B includes an integrated current sense circuit 590. As shown in the example of FIG. 9A, the integrated current sense circuit 590 is coupled to the drive circuitry 534 substrate 504 within the package 506 as switch feedback 537, which simplifies arrangement of integrated device 601. In addition, the integrated current sense circuit 590 may provide a highly accurate measurement of a current I_{SWITCH} 531 through the power switch 532B, which may enable the integrated device 601 to operate with improved efficiency.

In some examples, an integrated device 501, 601, 701 as depicted in FIGS. 8 and 9A-9C may include any type of power switch 532A-532C that is suitable to switch at fast speeds to control the transfer of energy as described herein. For example, the power switch 532A-532C may be a metal oxide semiconductor field effect transistor (MOSFET) formed in a silicon substrate material, i.e., a “silicon MOSFET.” In other examples, the power switch 532A-532C may be formed in a high electron mobility substrate material such as a III-V semiconductor like gallium nitride or silicon carbide. In some examples, the power switch 532A-532C may be a vertically arranged power switch, such as a silicon-based MOSFET transistor that includes a source terminal on a first side of the substrate 405, and a drain terminal on a second opposed side of the substrate 405 separated by a vertical conduction channel. According to other examples, the power switch 532A-532C may be a laterally arranged power switch 532C as shown in FIG. 9C, which includes gate, drain, and source terminals on the same substrate surface, for example, a laterally arranged gallium nitride or silicon carbide power switch. In examples where the power switch 532A-532C is a gallium nitride power switch, the gallium nitride power switch may be formed using an ohmic gate (also referred to as a “Gate Inject Transistor (GIT)”) or a Schottky gate structure. In some examples, a laterally arranged power switch 532C may include a current sense circuit 590, as shown in the FIG. 9A-9C examples.

FIG. 9B is a diagram that shows a top down via of an integrated device 701 that includes a package 506 that houses a first substrate 504 that implements driver circuitry 534 and a second substrate 505 that implements a power switch 532C adjacent to the first substrate 505 on a printed circuit board (PCB) 507. FIG. 9C is a diagram showing a side view of the integrated device 701 according to some embodiments. According to the example of FIGS. 9B and 9C, power switch 532C is a laterally arranged power switch that, like power switch 532B depicted in FIG. 9B, includes an integrated current sense circuit 590. As shown by the dashed boxes in FIG. 9B, power switch 532C includes gate drain, and source contact pads 511, as well as an ISENSE contact pad 511 on the same planar surface of substrate 505, arranged in contact with the PCB 507. According to this example, the driver circuitry 534 is coupled to a gate of the power switch 532C via a lateral trace 513 on or in the PCB 507, and the driver circuitry 534 is coupled to a contact of the integrated current sense circuit 590 by another lateral trace 513 on or in the PCB 507. Similarly, a first I/O port 508A of the package 506 is coupled by another lateral trace 513 and a contact pad 511 to the mode select input 536 of the driver circuitry 534, and a second I/O port 508B of the package 506 is coupled by another lateral trace 513 and a contact pad 511 to a driver input signal 542 from a controller. As also shown in FIGS. 9B and 9C, drain and source contact pads are coupled to I/O ports 508C and 508D on package 506, to enable connection to the respective drain and source terminal by other components of a converter 100 as shown in the FIG. 1 example.

The integrated devices 501, 601, 701 depicted in FIGS. 9A-9C, which implement driver circuitry 234 that is configurable to operate in first and second modes, may be particularly suitable for some applications by offering direct and short conductors. In some examples, an integrated device 701, which includes laterally arranged power switch 532C coupled to a configurable drive circuitry 234 within the package 506 with relatively short, lateral traces 513 may be relatively simple to manufacture and/or may operate with improved accuracy, and may increased efficiency and reduced power usage, in comparison with traditional power devices. In addition, an integrated device 601, 701, which includes an integrated current sense circuit 590, may further improve accuracy, and therefore efficiency, of a converter 100 that implements the integrated device 601, 701.

As mentioned above with respect to FIG. 1, in some examples, secondary side driver circuitry 134 and/or primary side driver circuitry 124 may be self-configurable to transition between operating in the first mode and second modes. According to these examples, the driver circuitry 134, 124 does not include a mode select inputs 136, 126. Instead, as shown by the dashed lines in FIGS. 7, 8, and 9A-9C, a device 400, or an integrated device 501, 601, and/or 701 may be formed without I/O ports 508A, 508B. According to these examples, the device 400, or an integrated device 501, 601, and/or 701 may be configured to support synchronous rectification and high converter efficiency with reduced number of control signals, and I/O ports, which may reduce cost to manufacture and/or implement a converter.

FIG. 10 is a block diagram depicting one example of a converter 800 that includes integrated devices 801A and 801B implemented as secondary side switches 132 of a converter 100, 200 as depicted in the examples of FIGS. 1 and 2. The integrated devices 801A and 801B may each be any of the integrated devices 501, 601, or 701 depicted in FIGS. 7-8 and 9A-9C. According to the example of FIG. 1, each integrated device 801A, 801B includes configurable driver circuitry 234 in a first substrate coupled to control a power switch 632A, 632B integrated in a second substrate housed in the same package 606A, 606B. Each of the packages 606A, 606B include a plurality of I/O ports 608A-608H and 618A-618H, respectively.

According to the example of FIG. 10, converter 800 may be implemented, using the integrated devices 801A and 801B, with minimal complexity. The first integrated device 801A includes an I/O port 608D that couples a drain of the power switch 632A to a low side of the transformer 610 secondary winding to operate as a low side switch. Similarly, the second integrated device 801B includes an I/O port 618A coupled to a high side of the secondary winding to operate as a high side switch. As also shown in FIG. 10, source terminals of the respective power switches 632A and 632B are coupled to one another, and a load (e.g., a low voltage battery) coupled to secondary side terminals 646A, 646B of the converter 800.

According to the example of FIG. 10, the controller 640 may control the integrated devices 801A and 801B using only a few control signals. As shown in FIG. 10, controller 640 may generate an “AUTO” control signal 636 coupled to the mode select inputs of each driver circuitry 634A, 634B through I/O ports 608A and 618C, to operate both integrated devices 801A and 801B in the first mode or the second mode concurrently. In addition, the controller 640 may generate respective OUTA and OUTB driver control signals as a driver input signal 642A to the integrated device 801A through I/O port 608B, and a driver input signal 642B to the integrated device 801B through I/O port 618D.

In other examples not depicted in FIG. 10, integrated devices 801A, 801B do not include the I/O ports 608A, 608B to receive the AUTO control signal from the controller 640, and instead are self-configurable. According to these examples, driver circuitry 634 of each of the integrated devices 801A, 801B is configured to determine a direction of current flow through the respective power switches 632A, 632B, and operate the driver circuitry in the first mode or the second mode based on the current flow direction.

FIG. 11 is a block diagram depicting one example of the driver circuitry 334 operable in a first mode or a second mode depicted in FIG. 6 with first and second circuits 734A, 734B housed in separate packages 706A, 706B as discrete components according to some embodiments. According to the FIG. 11 example, driver circuitry 334 is used to control a power switch 232, which may be used as a secondary side switch 132 and/or a primary side switch 122, of a power converter 100, 200 as shown in the examples of FIGS. 1 and 2. Each of the packages 706A, 706B include a plurality of I/O ports 708A-708H and 718A-718H, respectively.

According to the example of FIG. 11, the driver circuitry 334 includes a first circuit 734A implemented in a first substrate 704A in the first package 706A, and a second circuit 734B implemented in a second substrate 704B in a second package 706B. As described above with respect to FIG. 6, the first circuit 734A includes a first drive circuit 335A and is coupled to an I/O port 718D of the first package 706A and configured to generate a first driver output signal 339A to turn power switch 232 off based on a switch feedback 337 from the power switch 232, for example based on when the current I_{SWITCH} 231 crosses zero (e.g., based on a measured voltage VDS 233 across the power switch 232 or a measured current I_{SWITCH} 231 through the power switch 232) as described above with respect to FIG. 6. As also shown in FIG. 11, the first circuit 734A includes a first disconnect switch 380A implemented in the first substrate 704A coupled between the first drive circuit 335A output and an I/O port 718D, which is coupled to a gate of the power switch 232.

As described above with respect to FIG. 6, the second circuit 734B includes a second drive circuit 335B and is coupled through an I/O port 708E of the second package 706B to receive a driver input signal 742 from a controller 740, and generate a second driver output signal 339B to turn power switch 232 on and off based on the driver input signal 742. As shown in FIG. 11, the second circuit 734B includes a second disconnect switch 380B implemented in the second substrate 704B coupled between the second drive circuit 335B output and an I/O port 708H, which is coupled to a gate of the power switch 232.

As shown in the example of FIG. 11, the I/O ports 708H and 718D are coupled together to the gate of the power switch 232. As also shown in FIG. 11, each of the device packages includes an enable I/O port 708C, 718C that is coupled to an enable input of the respective first and second drive circuits 335A, 335B. As shown, each of the enable ports I/O port 708C, 718C are also coupled to a control gate of the respective disconnect switches 380A, 380B, such that a single control signal may decouple the respective driver output signals 339A, 339B from the power switch 232 gate, and also disable the respective drive circuits 335A, 335B. For example, to operate in the first mode, the controller 740 may generate a control signal 736A to enable the first drive circuit 335A and couple the first drive circuit 335A output to the power switch 232 gate. To operate in the first mode, the controller 740 may generate a control signal 736B (or an inverted version of control signal 736A) that disables the second drive circuit 335B, and causes the second disconnect switch 380B to decouple the second drive circuit 335B from the power switch 232.

To operate in the second mode, the controller 740 generates a control signal 736A to disable the first circuit 734A drive circuit 335A and causes the first disconnect switch 380A to decouple the first driver output signal 339A from the power switch 232 gate. To operate in the second mode, the controller 740 generates a control signal 736B (or an inverted version of control signal 736A) that enables the second drive circuit 335B, and causes the second disconnect switch 380B to couple the second drive circuit 335B to the power switch 232.

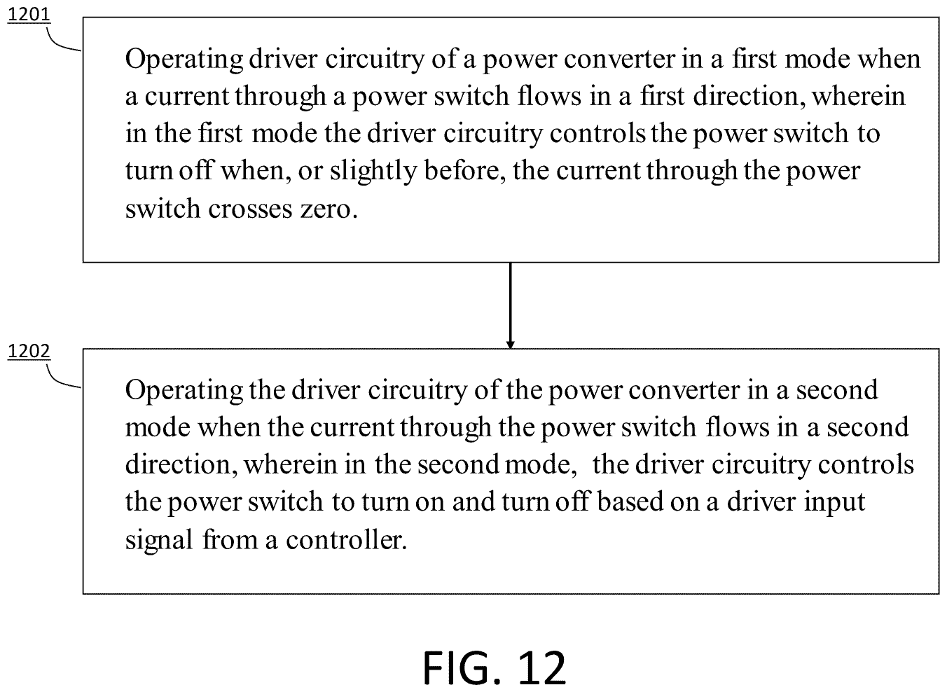

FIG. 12 is a flow diagram that depicts one example of a method of operating driver circuitry of a power converter according to some embodiments. As shown in FIG. 1, at step 1201, the method includes operating driver circuitry (e.g., 124, 134) of a power converter (e.g., 100) in a first mode when a current through a power switch (e.g., 122, 132) flows in a first direction (e.g., 160) from a source of the secondary side switch to a drain of the secondary side switch. In the first mode, the driver circuitry controls a power switch to turn off when, or slightly before, the current through the power switch crosses zero. According to one example, operating the driver circuitry in the first mode includes controlling the power switch to turn on when a body diode of the power switch begins to conduct, as shown in the embodiment 1A of FIG. 4A. In other examples, in the first mode, the method further includes controlling the power switch to turn off when, or slightly before, the current through the secondary side switch crosses zero, and controlling the power switch to turn on based on the driver input signal from the controller, as shown in the embodiment 1B of FIG. 4B.

As also shown in FIG. 12, at step 1202, the method includes operating the driver circuitry of the power converter in a second mode when the current through the power switch flows in a second direction (e.g., 162) from the drain of the power switch to the source of the power switch, wherein in the second mode, the driver circuitry controls the power switch to turn on and turn off based on a driver input signal (e.g., 142) from a controller (e.g., 140), for example as shown in FIG. 4C.

In some examples, the driver circuitry is integrated in a first semiconductor substrate (e.g., 504), and the secondary side switch (e.g., power switch 542B, 532C) is integrated with a current sense circuit (590) in a second semiconductor substrate (e.g. 505) housed in a package (e.g., 506) with the first semiconductor substrate. In some examples, the method includes operating the driver circuitry in the first mode or the second mode based on a control signal (e.g., 136) received at an I/O port of a package (e.g., 406A, 506) that houses the driver circuitry. In other examples, the method includes self-configuring the driver circuitry in the first mode or the second mode, based on a direction of current flow through the secondary side switch.

In some examples, the power switch is a secondary side power switch (e.g., 132) and the method includes operating the driver circuitry in the first mode to control the secondary side switch to transfer energy from a primary side (e.g., 120) of a power converter (e.g., 100, 200) to a secondary side (e.g., 130) of the power converter. In some examples, the method further includes operating the driver circuitry in the second mode to control the secondary side switch to transfer energy from the secondary side of the power converter to the primary side of the power converter.

In some examples, the power switch is a primary side switch (e.g., 122) and the method includes operating the driver circuitry in the first mode to control the primary side switch when energy is transferred from the secondary side of the power converter to the primary side of the power converter. In some examples, the method further includes operating the driver circuitry in the second mode to control the primary side switch when energy is transferred from the primary side of the power converter to the secondary side of the power converter.

### DISCUSSION OF POSSIBLE EMBODIMENTS

The following are non-exclusive descriptions of possible embodiments of the present invention.

According to one example, in some aspects, an integrated device includes driver circuitry configured to, in a first mode when a current through a power switch flows in a first direction from a source of the power switch to a drain of the power switch, control the power switch to turn off when, or slightly before, the current through the power switch crosses zero. The driver circuitry is further configured to, in a second mode when the current through the power switch flows in a second direction from the drain of the power switch to the source of the power switch, control the power switch to turn on and turn off based on a driver input. signal from a controller.

The integrated device of the preceding paragraph may optionally include, additionally and/or alternatively, any one or more of the following features, configurations and/or additional components alone or in combination with one another. For example, according to some aspects, the integrated device further includes a package that houses the driver circuitry, and the driver circuitry includes a drive circuit configurable to operate in the first mode or the second mode based on a control signal received at an I/O port of the package. According to another example, in some aspects, the I/O port is a first I/O port, and the package includes a second I/O port coupled to receive the driver input signal from the controller. According to another example, in some aspects, the power switch is housed in a package with the driver circuitry. According to another example, in some aspects, the driver circuitry is coupled to a current sensing circuit monolithically integrated with the power switch. According to another example, in some aspects, the power switch is a gallium nitride power switch. According to another example, in some aspects, the power switch is a laterally arranged power switch. According to another example, in some aspects, in the first mode, the driver circuitry is configured to turn on the power switch based on the driver input signal from the controller, and turn off the power switch when, or slightly before, a current through the secondary side switch crosses zero. According to another example, in some aspects, the driver circuitry is further configured to, in the second mode, disconnect from power one or more of: a zero crossing detector that operates to turn off the power switch when, or slightly before, a current through the secondary side switch crosses zero, and a current sense circuit used to measure the current through the power switch. According to another example, in some aspects, the driver circuitry includes: a first driver circuit configured to determine when the current through the power switch crosses zero and turn off the power switch, and a second driver circuit configured to control the secondary side switch based on the driver input signal from the controller. According to another example, in some aspects, the power switch is a secondary side power switch, and the controller also controls a primary side switch to turn on and to turn off synchronously with the secondary side switch. According to another example, in some aspects, the power switch is a secondary side switch, and the driver circuitry is configured to operate in the first mode to transfer energy from a primary side of a power converter to a secondary side of the power converter. According to another example, in some aspects, the power switch is a secondary side switch, and the driver circuitry is configured to operate in the second mode to transfer energy from a secondary side of a power converter to a primary side of the power converter.

According to another example, a bi-directional power converter includes a primary side of a transformer that includes a primary side switch and a primary side terminal. The bi-directional power converter further includes a secondary side of the transformer that includes a secondary side switch and a secondary side terminal. The bi-directional power converter further includes driver circuitry configured to drive the secondary side switch, and controllable to operate in: a first mode in which the driver circuitry controls the secondary side switch to transfer energy from the primary side terminal to the secondary side terminal based on causing the secondary side switch to turn off when, or slightly before, a current through the secondary side switch crosses zero, and a second mode in which the driver circuitry controls the secondary side switch to turn on and turn off to transfer energy from the secondary side terminal to the primary side terminal based a driver input signal from a controller.

The bi-directional power converter of the preceding paragraph may optionally include, additionally and/or alternatively, any one or more of the following features, configurations and/or additional components alone or in combination with one another.

According to one example, in some aspects, operating the driver circuitry in the first mode includes turning on the secondary side switch based on the driver input signal from the controller, and turning off the secondary side switch when, or slightly before, a current through the secondary side switch crosses zero. According to another example, in some aspects, the secondary side switch is integrated with the driver circuitry in a package. According to another example, in some aspects, the secondary side switch is a laterally arranged gallium nitride power switch integrated in a substrate with a current sensing circuit. According to another example, in some aspects, the bi-directional power converter includes a package that houses the driver circuitry, and the driver circuitry includes a drive circuit configurable to operate in the first mode or the second mode based on a control signal received at an I/O port of the package. According to another example, in some aspects, the driver circuitry includes: a first driver circuit configured to cause the secondary side switch to turn off when, or slightly before, a current through the secondary side switch crosses zero, and a second driver circuit to turn on and turn off based the driver input signal from the controller.

According to another example, in some aspects, the bi-directional power converter further includes a first decoupling switch arranged to decouple the first driver circuit from a gate terminal of the secondary side switch, and a second decoupling switch arranged to decouple the second driver circuit from the gate terminal of the secondary side switch. According to another example, in some aspects, the first driver circuit is housed in a first package, and the second driver circuit is housed in a second package different than the first package. According to another example, in some aspects, a control terminal of the first decoupling switch is coupled to an enable port of the first package, and a control terminal of the second decoupling switch is coupled to an enable port of the second package.

According to another example, a method includes operating driver circuitry of a power converter in a first mode when a current through a power switch flows in a first direction from a source of the power switch to a drain of the power side switch, wherein in the first mode the driver circuitry controls a power switch to turn off when, or slightly before, the current through the power switch crosses zero. The method further includes operating the driver circuitry of the power converter in a second mode when the current through the power switch flows in a second direction from the drain of the power switch to the source of the power switch, wherein in the second mode, the driver circuitry controls the power switch to turn on and turn off based on a driver input signal from a controller.

The method of the preceding paragraph may optionally include, additionally and/or alternatively, any one or more of the following features, configurations and/or additional steps alone or in combination with one another.

According to one example, in some aspects, the method includes operating the driver circuitry in the first mode or the second mode based on a control signal received at an I/O port of a package that houses the driver circuitry. According to another example, in some aspects, operating the driver circuitry in the first mode includes turning on the power switch based on the driver input signal from the controller, and turning off the power when, or slightly before, a current through the secondary side switch crosses zero. According to another example, in some aspects, the driver circuitry is integrated in a first semiconductor substrate, and the power switch is integrated with a current sense circuit in a second semiconductor substrate housed in a package with the first semiconductor substrate. According to another example, in some aspects, the method further includes operating the driver circuitry in the first mode to transfer energy from a primary side of a power converter to a secondary side of the power converter. According to another example, in some aspects, the method further includes operating the driver circuitry in the second mode to transfer energy from a secondary side of a power converter to a primary side of the power converter.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. An integrated device, comprising:
driver circuitry configured to, in a first mode when a current through a power switch flows in a first direction from a source of the power switch to a drain of the power switch, control the power switch to turn off when, or slightly before, the current through the power switch crosses zero; and
in a second mode when the current through the power switch flows in a second direction from the drain of the power switch to the source of the power switch, control the power switch to turn on and turn off based on a driver input signal from a controller.

2. The integrated device of claim 1, further comprising:
a package that houses the driver circuitry, and the driver circuitry includes a drive circuit configurable to operate in the first mode or the second mode based on a control signal received at an I/O port of the package.

3. The integrated device of claim 2, wherein the I/O port is a first I/O port, and the package includes a second I/O port coupled to receive the driver input signal from the controller.

4. The integrated device of claim 3, wherein the power switch is housed in a package with the driver circuitry.

5. The integrated device of claim 4, wherein the driver circuitry is coupled to a current sensing circuit monolithically integrated with the power switch.

6. The integrated device of claim 4, wherein the power switch is a gallium nitride power switch.

7. The integrated device of claim 4, wherein the power switch is a laterally arranged power switch.

8. The integrated device of claim 1, wherein, in the first mode, the driver circuitry is configured to turn on the power switch based on the driver input signal from the controller, and turn off the power switch when, or slightly before, a current through the power switch crosses zero.

9. The integrated device of claim 1, wherein the driver circuitry is further configured to, in the second mode, disconnect from power one or more of:
a zero crossing detector that operates to turn off the power switch when, or slightly before, a current through the secondary side switch crosses zero; and
a current sense circuit used to measure the current through the power switch.

10. The integrated device of claim 1, wherein the driver circuitry includes:
a first driver circuit configured to determine when the current through the power switch crosses zero and turn off the secondary side switch; and
a second driver circuit configured to control the power switch based on the driver input signal from the controller.

11. The integrated device of claim 1, the power switch is a secondary side switch and the controller also controls a primary side switch to turn on and to turn off synchronously with the secondary side switch.

12. The integrated device of claim 1, wherein the power switch is a secondary side switch and the driver circuitry is configured to operate in the first mode to transfer energy from a primary side of a power converter to a secondary side of the power converter.

13. The integrated device of claim 1, wherein the power switch is a secondary side switch and the driver circuitry is configured to operate in the second mode to transfer energy from a secondary side of a power converter to a primary side of the power converter.

14. A bi-directional power converter, comprising:
a primary side of a transformer that includes a primary side switch and a primary side terminal;
a secondary side of the transformer that includes a secondary side switch and a secondary side terminal; and
driver circuitry configured to drive the secondary side switch, and controllable to operate in:
a first mode in which the driver circuitry controls the secondary side switch to transfer energy from the primary side terminal to the secondary side terminal based on causing the secondary side switch to turn off when, or slightly before, a current through the secondary side switch crosses zero; and
a second mode in which the driver circuitry controls the secondary side switch to turn on and turn off to transfer energy from the secondary side terminal to the primary side terminal based a driver input signal from a controller.

15. The bi-directional power converter of claim 14, wherein operating the driver circuitry in the first mode includes turning on the secondary side switch based on the driver input signal from the controller, and turning off the secondary side switch when, or slightly before, a current through the secondary side switch crosses zero.

16. The bi-directional power converter of claim 14, wherein the secondary side switch is integrated with the driver circuitry in a package.

17. The bi-directional power converter of claim 14, wherein the secondary side switch is a laterally arranged gallium nitride power switch integrated in a substrate with a current sensing circuit.

18. The bi-directional power converter of claim 14, further comprising:
a package that houses the driver circuitry, and the driver circuitry includes a drive circuit configurable to operate in the first mode or the second mode based on a control signal received at an I/O port of the package.

19. The bi-directional power converter of claim 14, wherein the driver circuitry includes:
a first driver circuit configured to cause the secondary side switch to turn off when, or slightly before, a current through the secondary side switch crosses zero; and
a second driver circuit to turn on and turn off based the driver input signal from the controller.

20. The bi-directional power converter of claim 19, further comprising:
a first decoupling switch arranged to decouple the first driver circuit from a gate terminal of the secondary side switch; and
a second decoupling switch arranged to decouple the second driver circuit from the gate terminal of the secondary side switch.

21. The bi-directional power converter of claim 20, wherein the first driver circuit is housed in a first package, and the second driver circuit is housed in a second package different than the first package.

22. The bi-directional power converter of claim 21, wherein a control terminal of the first decoupling switch is coupled to an enable port of the first package, and a control terminal of the second decoupling switch is coupled to an enable port of the second package.

23. A method, comprising:
operating driver circuitry of a power converter in a first mode when a current through a power switch flows in a first direction from a source of the power switch to a drain of the power switch, wherein in the first mode the driver circuitry controls a power switch to turn off when, or slightly before, the current through the power switch crosses zero; and
operating the driver circuitry of the power converter in a second mode when the current through the power switch flows in a second direction from the drain of the power switch to the source of the power switch, wherein in the second mode, the driver circuitry controls the power switch to turn on and turn off based on a driver input signal from a controller.

24. The method of claim 23, further comprising operating the driver circuitry in the first mode or the second mode based on a control signal received at an I/O port of a package that houses the driver circuitry.

25. The method of claim 23, wherein operating the driver circuitry in the first mode includes turning on the power switch based on the driver input signal from the controller, and turning off the power switch when, or slightly before, a current through the secondary side switch crosses zero.

26. The method of claim 23, wherein the driver circuitry is integrated in a first semiconductor substrate, and the power switch is integrated with a current sense circuit in a second semiconductor substrate housed in a package with the first semiconductor substrate.

27. The method of claim 23, further comprising:
operating the driver circuitry in the first mode to transfer energy from a primary side of a power converter to a secondary side of the power converter.

28. The method of claim 23, further comprising:
operating the driver circuitry in the second mode to transfer energy from a secondary side of a power converter to a primary side of the power converter.
